(19) United States
(12) Patent Application Publication
(10) Pub. No.: US 2026/0361694 A1
(43) Pub. Date: Nov. 12, 2026

(54) LOCALIZED CONTEXT-BASED SCREENING OF LANGUAGE MODEL INPUTS

(71) Applicant: The Regents of the University of Michigan, Ann Arbor, MI (US)

(72) Inventors: Zaid Ghazal, Dearborn, MI (US); Waseem Al Khatib, Dubai (AE)

(21) Appl. No.: 19/671,894

(22) Filed: May 8, 2026

Related U.S. Application Data
(60) Provisional application No. 63/803,532, filed on May 9, 2025.

(51) Int. Cl. H04L 9/40; G06F 40/284; G06F 40/295; G06F 40/30; G06F 40/40

(52) U.S. Cl. CPC H04L 63/04; G06F 40/284; G06F 40/295; G06F 40/30; G06F 40/40

(57) ABSTRACT

A system, tool, and method for a method of locally safeguarding sensitive information from a third party natural language processing (NLP) application. The system and tool are each configured to perform the method. The method includes: receiving an indication of an intention of a native computer application to send a remote network request to a third party NLP application, wherein the remote network request has a natural language model input for the third party NLP application; performing syntactical sensitive information detection on the natural language model input; performing contextual sensitive information detection on the natural language model input; determining a safeguarding action based on an output of the syntactical sensitive information detection and/or an output of the contextual sensitive information detection; and performing the safeguarding action in order to safeguard sensitive information contained within the natural language model input.

### BACKGROUND

Recently, natural language processing (NLP) technology, including contextual text analysis and generation, has been on a sharp rise in popularity ever since ChatGPT™ and other like large language models (LLMs) (e.g., ChatGPT™ and other transformer-based, generative artificial intelligence (AI)) hit the markets and media. Indeed, such technologies have resulted in the introduction of AI, particularly machine learning (ML) based NLP, to numerous different industries.

This widespread AI-NLP phenomenon has not come without its concerns. Of these, handling of confidential or otherwise sensitive information is at the forefront, as use of these state of the art (SOTA) NLP-AI models, such as ChatGPT™, is typically effected as a result of information being sent over a remote computer network, particularly one not owned, managed, or controlled by the party requesting use of such services (a “third party service provider”).

SOTA NLP-AI models are generally quite large in size (e.g., tens or hundreds or billions of parameters) and executed on specialized ML/AI processing equipment, such as specialized graphics processing units (GPUs), tensor processing units (TPUs), etc. Thus, service providers, such as OpenAI™, provide access to a variety of NLP-AI models, such as Anthropic™ Claude™ or OpenAI's GPT models (e.g., gpt-4o, gpt-4.5), for example. Nonetheless, when a user wants to use such NLP-AI services, particularly in connection with processing a natural language model input, the natural language model input is sent (as a “prompt”) to the service provider's system for use in performing inference using its large NLP-AI model(s). Accordingly, there is a risk that confidential or otherwise sensitive information contained in natural language model inputs is used in an impermissible manner, such as for purposes of training NLP-AI models or selling such information to other parties.

Thus, in this context, sensitive data leakage is a significant concern, especially with the rise in widespread usage and adoption of LLMs. As users interact with these models, there is a growing need to protect sensitive information from being unintentionally shared or leaked. Also, there is a growing need to effect such protection without hindering users from fully utilizing the capabilities of LLMs or other SOTA NLP-AI models.

### SUMMARY

In accordance with a first aspect of the invention, there is provided a method of locally safeguarding sensitive information from a third party natural language processing (NLP) application. The method includes: receiving an indication of an intention of a native computer application to send a remote network request to a third party NLP application, wherein the remote network request has a natural language model input for the third party NLP application; performing syntactical sensitive information detection on the natural language model input; performing contextual sensitive information detection on the natural language model input; determining a safeguarding action based on an output of the syntactical sensitive information detection and/or an output of the contextual sensitive information detection; and performing the safeguarding action in order to safeguard sensitive information contained within the natural language model input.

According to various embodiments, the method of the first aspect of the invention may further include any one of the following features or any technically-feasible combination of some or all of these features:
the steps of the method are each performed by the client computer so that the safeguarded natural language model input is generated at the client computer and sent by the client computer using a network interface of the client computer;
the native computer application is a web browser for browsing the internet or other remote computer networks;
the method is performed by an information safeguarding computer tool that is executed in a daemon-like fashion relative to the native computer application;
the native computer application is a web browser;
the information safeguarding computer tool is a browser extension;
the syntactical sensitive information detection is performed through executing textual pattern matching on the natural language model input in order to identify one or more matching text strings;
the textual pattern matching includes one or more regular expressions;
the textual pattern matching is a part of a textual pattern matching process that includes: the output of the syntactical sensitive information detection is based on the detection result, determining distance information indicating a character distance between the text string and a keyword, and/or determining a detection result based on the character distance;
the output of the syntactical sensitive information detection is based on the detection result;
the textual pattern matching includes at least one of from a list consisting of. Social Security Number (SSN) or other jurisdictional personal identifier detection, date detection, email detection, credit card number detection, phone number detection, address detection, financial account information detection, URL detection, and code snippet detection;
the textual pattern matching includes at least three from the list;
the output of the contextual sensitive information detection is based on an output generated by a trained NLP model operating on the natural language model input;
the output of the contextual sensitive information detection indicates a classification of an intent of sharing the natural language model input;
the classification indicates whether the intent of sharing the natural language model input is benign or malicious;
the output of the contextual sensitive information detection is determined through tokenizing characters or strings of the natural language model input using the trained NLP model in order to generate tokenized input data;
the tokenized input data indicates one or more key phrases or entities;
the output of the contextual sensitive information detection is determined through performing inference on the natural language model input using the trained NLP model;
the trained NLP model produces an output as a result of performing the inference on the natural language model input;
the output of the trained NLP model indicates an intent of sharing the natural language model input to another party;
the trained NLP model includes a neural network (NN) that performs the inference on the natural language model input in order to generate the output of the contextual sensitive information detection;
the output of the contextual sensitive information detection is determined through: generating an output of a trained NLP model, determining a confidence score for the inferred aspect of the natural language model input, and/or determining the output of the contextual sensitive information detection based on the confidence score;
the output of the trained NLP model indicates an inferred aspect of the natural language model input;
the inferred aspect of the natural language model input is an intent of sharing the natural language model input;
the output of the contextual sensitive information detection indicates a classification of the intent of sharing the natural language model input;
the safeguarding action is prompting a user with information concerning sensitive information detected within the natural language model input;
the safeguarding action includes generating a safeguarded natural language model input constituting a safeguarded version of the natural language model input and causing the safeguarded natural language model input to be sent to the third party NLP application instead of the natural language model input;
sensitive information detected within the natural language model input is redacted or otherwise masked and the safeguarded natural language model input thereby generated prior to any version of the natural language model input being sent out of a local network of the client computer;
the safeguarding action is preventing the natural language model input from being sent out of a local network of the client computer;
an information-action map (IAM) is determined based on the syntactical sensitive information detection of the natural language model input and the contextual sensitive information detection of the natural language model input;
the IAM is used for determining the safeguarding action;
the output of the syntactical sensitive information detection and/or the output of the contextual sensitive information detection indicates one or more sensitive information items within the natural language model input;
each of the one or more sensitive information items is assigned an action for safeguarding potentially sensitive information contained therein;
the sensitive information is an output of a first natural language processing (NLP) tool, and the safeguarding action is used to generate a safeguarded first NLP output;
the safeguarded first NLP output is used as input into a second NLP tool;
the first NLP tool and/or the second NLP tool is an agent or separate computer application;
each of the first NLP tool and the second NLP tool is an agent, and agent-to-agent communications between the first NLP tool and the second NLP tool are safeguarded by the safeguarding action;
each of the first NLP tool and the second NLP tool is a separate computer application, and application-to-application communications between the first NLP tool and the second NLP tool are safeguarded by the safeguarding action;
the sensitive information is an input to be used by a computer tool, and the safeguarding action is used to generate a safeguarded tool input;
the safeguarded tool input is used as input for the computer tool in order to generate a tool output; and/or
the tool output of the computer tool is safeguarded by the safeguarding action in order to generate a safeguarded tool output.

In accordance with a second aspect of the invention, there is provided a client-side data safeguarding tool. The client-side includes: a host application interface for communication with a computer application being executed on a client computer, wherein the computer application is a web browser; a sensitive information detector for detecting sensitive information contained within a natural language model input to be sent over a data communications network to an application hosted by a third party; an actions assigner for receiving sensitive information data concerning the sensitive information and assigning an action to the sensitive information data; and an actions handler for causing execution of the assigned action in order to include a safeguarded version of the sensitive information in place of the sensitive information as originally presented in the natural language model input.

According to various embodiments, the client-side data safeguarding tool of the second aspect of the invention may further include any one or more of those features discussed above in connection with the first aspect of the invention.

In accordance with a third aspect of the invention, there is provided a method of locally safeguarding sensitive information from a third party natural language processing (NLP) application. The method includes: installing on-premise information safeguarding computer instructions at a client computer, wherein the client computer is configured to execute native computer instructions in order to provide a native computer application usable for initiating network requests from the client computer to one or more third party endpoints; executing the on-premise information safeguarding computer instructions at the client computer in order to provide an information safeguarding computer tool, wherein the information safeguarding computer tool is configured to: receive an indication of an intention of the native computer application to send a remote network request to a third party application, wherein the remote network request has potentially sensitive content that is to be sent to a third party using the third party application; detect sensitive information contained within the potentially sensitive content; assign a safeguarding action to the detected sensitive information; and perform the safeguarding action in order to generate a safeguarded natural language model input constituting a safeguarded version of the natural language model input and cause the safeguarded natural language model input to be sent to the third party NLP application instead of the natural language model input.

According to various embodiments, the method of the third aspect of the invention may further include any one or more of those features discussed above in connection with the first and/or second aspect of the invention and/or any of the following features or any technically-feasible combination of some or all of these features:
the one or more endpoints include an endpoint at which a third party NLP application receives requests from the native computer application and provides NLP application responses to natural language model inputs received as part of the requests;
the safeguarding action is performed in order to safeguard the sensitive information contained within the natural language model input so that no potentially-sensitive information reaches the third party application; and/or
the tool is configured to perform the method of the first or second aspect of the invention.

In accordance with a fourth aspect of the invention, there is provided a client-side data safeguarding tool. The client-side includes: a host application interface for communication with a computer application being executed on a client computer; a sensitive information detector for detecting sensitive information contained within potentially-sensitive content to be sent over a data communications network to an third party application, wherein the third party application is a computer application hosted by a third party, and wherein the sensitive information detector includes: a local sensitive information detector configured to process the potentially-sensitive content in order to determine a syntactical sensitive information detection output, and a remote sensitive information detector comprised of a language model configured to process the potentially-sensitive content in order to determine a contextual sensitive information detection output; wherein the sensitive information detector is configured to: receive an indication of content to be sent over the data communications network to the third party application prior to the content being sent to the third party application; generate the syntactical sensitive information detection output for the content to be sent to the third party application; transmit a content message to be sent to the remote sensitive information detector; receive the content message at the remote sensitive information detector, wherein the content message is a message having or otherwise indicating the content to be sent to the third party application; generate the contextual sensitive information detection output for the content to be sent to the third party application based on the received content message; send the contextual sensitive information detection output to the local sensitive information detector; and determine whether to allow the content to be sent to the third party application to be sent without safeguarding any information contained within the content to be sent to the third party application.

According to various embodiments, the client-side data safeguarding tool of the fourth aspect of the invention may further include any one or more of those features discussed above in connection with the first, second, and/or third aspect of the invention.

In accordance with a fifth aspect of the invention, there is provided an extension-based data safeguarding tool for safeguarding a native computer application. The extension-based includes: an extension configured for safeguarding information contained or accessible by the native computer application when executing on a general-purpose computer; wherein the native computer application is a computer application configured to run on the general-purpose computer within a local client network where access by the computer application to resources of the general-purpose computer or other devices of the local client network is managed by an operating system (OS) of the general-purpose computer; wherein the extension is configured to: receive an indication of an intention to send a remote network request; perform sensitive information detection on potentially-sensitive content to be included in the remote network request; and output a sensitive information output indicating whether the remote network request includes sensitive information and/or is to be safeguarded prior to transmission of the remote network request to the third party application and out of the local client network.

According to various embodiments, the extension-based data safeguarding tool of the fifth aspect of the invention may further include any one or more of those features discussed above in connection with the first, second, third, and/or fourth aspect of the invention and/or any of the following features or any technically-feasible combination of some or all of these features:
the native computer application is a web browser;
the extension is a browser extension for web browser;
the extension is configured as a local portion of the safeguarding tool that is executed at the local client network;
the client-side data safeguarding tool further includes a remote portion that is executed at a computer network that is remote to the local client network;
the remote portion includes a large language model (LLM) executor configured to execute a LLM with the potentially-sensitive content as input into the LLM in order to determine a contextual sensitive information detection output;
the contextual sensitive information detection output is sent from the remote portion to the extension;
the extension is configured to determine the sensitive information output based on the contextual sensitive information detection output;
the LLM is a vision-enable LLM, and wherein the potentially-sensitive content includes photographs, images, or other visually-represented content; and/or
the potentially-sensitive content is processed as a natural language model input that is to be provided to a third party computer application for use as an input into a language model.

In accordance with a sixth aspect of the invention, there is provided a distributed, dual-purpose data safeguarding tool for safeguarding a native computer application. The distributed, includes: a local detector comprised of a computer application having a secured intra-tool remote network interface and a host application interface for interfacing with a native computer application executing on a general-purpose computer; a remote detector comprised of a computer application configured to execute a large language model (LLM) on potentially-sensitive information in order to generate an output used for safeguarding the potentially-sensitive information from a third party of a third party computer application; wherein the secured intra-tool remote network interface of the local detector is used for establishing a secured communications channel between the local detector and the remote detector so that information sent between the local detector and the remote detector is secured in a manner so that the third party is unable to access salient information contained within the potentially-sensitive content; wherein the data safeguarding tool is configured to: receive an indication of content to be sent over the data communications network to the third party application prior to the content being sent to the third party application; receive a content message at the remote detector via the secured communications channel, wherein the content message is a message having or otherwise indicating the content to be sent to the third party application; generate the output at the remote detector based on the content to be sent to the third party application; send the output from the remote detector to the local detector via the secured communications channel; and determine whether to allow the content to be sent to the third party application to be sent without safeguarding any information contained within the content to be sent to the third party application.

According to various embodiments, the distributed, dual-purpose data safeguarding tool of the sixth aspect of the invention may further include any one or more of those features discussed above in connection with the first, second, third, fourth, and/or fifth aspect of the invention.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram depicting a computer communications system having a local client network, a third party computer system, an interconnected data communications network, and a client-side natural language processing (NLP) data safeguarding tool, according to one embodiment;

FIG. 2 is a block diagram depicting the local client network of FIG. 1 including a safeguarding application 30, according to one embodiment;

FIG. 3 is a block diagram depicting the client-side NLP data safeguarding tool of FIG. 1 as embodied by the safeguarding application of FIG. 2, according to one embodiment;

FIG. 4 is a block flow diagram depicting a sensitive information detector (SID) that may be used as a part of the safeguarding application of FIG. 2, according to one embodiment;

FIG. 5 is a block flow diagram depicting a process of assigning a safeguarding action to sensitive information and that may be used as a part of the safeguarding application of FIG. 2, according to one embodiment;

FIG. 6 is a block flow diagram of a computer communications system that may be used as a part of the computer communications system of FIG. 1, according to one embodiment;

FIG. 7 is a flowchart illustrating a method of locally safeguarding sensitive information from a third party NLP application, according to one embodiment;

FIG. 8 is a block diagram of a computer communications system having a local client network, a third party NLP computer system, and an interconnected data communications network, according to one embodiment;

FIG. 9 is a block flow diagram of an artificial intelligence (AI) lingual agent communication system having a first NLP tool, the safeguarding application of FIG. 2, and a second NLP tool, according to one embodiment; and

FIG. 10 is a block flow diagram of an AI and tool data pass communication system having the safeguarding application of FIG. 2 and a tool, according to one embodiment.

### DETAILED DESCRIPTION

The system and method described herein enables safeguarding sensitive information from a third party computer application, including, at least according to aspects, safeguarding content to be sent out of a local computer network for natural language processing (NLP) by a third party.

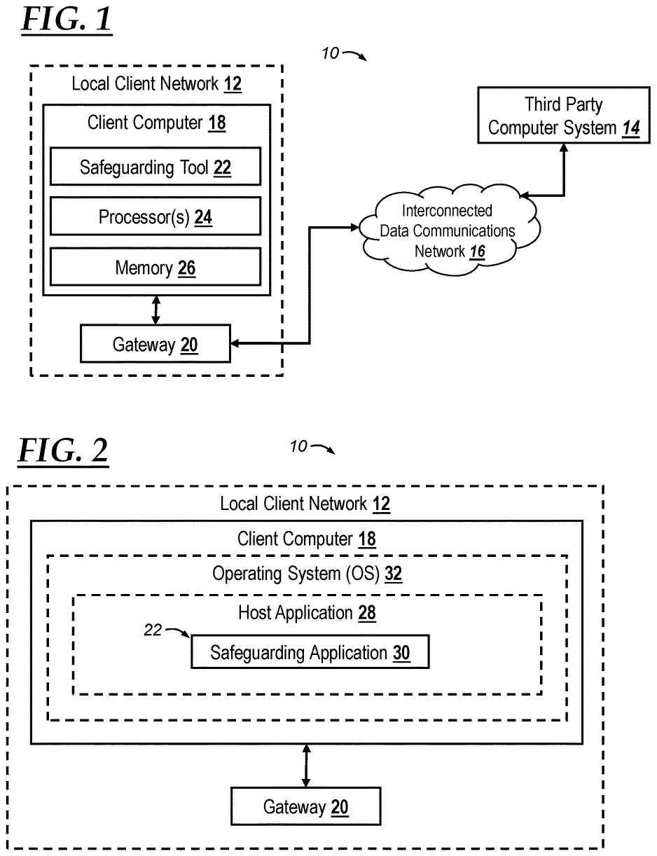

With reference to FIG. 1, there is shown a computer communications system 10 having a local client network 12, a third party computer system 14, and an interconnected data communications network 16 for enabling electronic data communications between the local client network 12 and the third party computer system 14. In the present embodiment, the local client network 12 has a client computer 18 as well as a gateway 20 for routing communications between the client computer 18 and the interconnected data communications network 16. The client computer 18 is used for determining a natural language model input to be sent via the gateway 20 to the third party computer system 14 for processing, but this natural language model input is captured or otherwise obtained and evaluated or otherwise inspected by a client-side NLP data safeguarding tool 22.

The local client network 12 refers to a private, localized communication network that interconnects computers within a limited geographical area, such as a home, office, building, campus, or manufacturing or industrial site. The local client network 12 in the present embodiment is implemented through use of local area network (LAN) protocoling technologies, such as, for example, Institute of Electrical and Electronics Engineers (IEEE) 802.3 for LAN or IEEE 802.11 for wireless LAN (WLAN). The local client network 12 includes any number and/or variety of different networking devices, hardware, and other componentry in order to enable local communications to be carried out amongst devices within the local client network 12, such as, for example, through Wi-Fi™ using WLAN or through use of category 5 or 6 twisted pair cabling terminated at each end with RJ45 compatible connectors, for example. The local client network 12 may include a plurality of subnetworks, each provisioned and managed by a different network router. In other embodiments, the local client network 12 is or includes a personal area network (PAN), such as those using IEEE 802.15, for example.

The third party NLP computer system 14 is an NLP computer system that is owned, managed, and/or controlled by a different party/organization than that of the client computer 18 and its user(s). As used herein, an NLP computer system is a computer system having at least one computer configured to perform NLP on a given input. The third party NLP computer system 14 is not accessible or controllable by the client computer 18 or any of its users, as the third party NLP computer system 14 is controlled by a separate party that supplies NLP services, such as NLP software-as-a-service (SaaS) or cloud services. For example, in one embodiment, the NLP computer system 14 refers to OpenAI's ChatGPT™ platform; and, in another embodiment, the NLP computer system 14 refers to other natural language processing models, such as Google's Gemini™, Anthropic's Claude™, or Meta's LLaMA™. The third party NLP computer system 14 includes its own local network that is separate from the local client network 12 and located at different premises/a different geographic location.

The third party NLP computer system 14 is configured to receive NLP service requests from client machines of one or more, often a variety of different and unrelated, individuals or parties. And, further, the third party NLP computer system 14 is configured to generate a response to each of the NLP service requests and to send the generated responses to the respective requestor, one of which may be, for example, the client computer 18. The NLP services provided by the third party NLP computer system 14 include, for example, text or language generation, text or language classification, image generation, image classification, and/or any combination thereof.

Each of the NLP service requests includes a natural language model input that is to be input into an NLP model, which may be, for example, a pretrained LLM. The natural language model input may be, for example, textual characters, such as a string of alphabetical characters, numbers, punctuation characters, whitespace characters, mathematical or symbolic characters, etc. In another embodiment, the natural language model input is in the form of speech, such as in the form of a digital audio file having data representing speech spoken by a person and captured by a microphone. In some embodiments, the natural language model input is a textual prompt for an LLM that includes a question, instruction, or other information or data, which, as those skilled in the art will appreciated, is often referred to as a “prompt” and is typically prepared with the intention and design of eliciting a response of a particular nature or character from the NLP model. The natural language model inputs may be stored and maintained in non-transitory, computer-readable memory for a non-transitory period of time. Here, for avoidance of doubt, the term “non-transitory”, when used in connection with a period of time, refers to the period of time being at least one week in duration.

Furthermore, in embodiments, the third party NLP computer system 14 may send the natural language model inputs and/or information derived therefrom to one or more other parties, meaning that the third party of the third party NLP computer system 14 and the other party/parties have access to the natural language model inputs. In an exemplary scenario, natural language model inputs comprised of text characters received at the third party NLP computer system 14 are stored into storage of the third party NLP computer system 14, such as in a cloud-hosted and/or managed database (e.g., Amazon DynamoDB™). Information received at the third party NLP computer system 14 from any of the devices of the local client network 12 may be stored in such storage, according to embodiments.

In addition to the client computer 18 and the gateway 20, the local client network 12 may include any of a variety of other computers or devices, such as, for example, other client computers, servers, network switches, routes, modems, etc. The local client network 12 is a network that communicatively connects computers and other devices within a limited geographic area, such as a home, office, or building. The local client network 12 may be connected to other networks via the gateway 20.

According to embodiments including the presently-illustrated embodiment, the client-side NLP data safeguarding tool 22 is installed onto the client computer 18 and is executed thereby in order to perform the method described herein. The client computer 18 includes at least one processor 24 and memory 26 storing computer instructions that, when executed, provide for the functionality of the client computer 18 as discussed herein. The client computer 18 may be, for example, a personal computer (e.g., desktop computer, laptop, tablet, smartphone).

The gateway 20 is used for enabling communications between the local client network 12 and the third party NLP computer system 14, as well as other remote computer systems or networks. The gateway 20 may be implemented using any of a variety of hardware, equipment, and/or other componentry, such as through use of one or more routers and modems, for example. The gateway 20 may include a firewall, a network switch, or other networking hardware, as well as various software components for implementing network protocols, encryption/decryption, and access control mechanisms. In some implementations, the gateway 20 may be configured to perform traffic monitoring, data caching, and load balancing to optimize network performance. For example, in embodiments, the gateway 20 is implemented using hardware such as Cisco ASA™, Palo Alto Networks™ firewalls, or Fortinet FortiGate™ Additionally, the gateway 20 may support various communication protocols, including but not limited to hypertext transport protocol (HTTP), HTTP with transport layer security (HTTPS), WebSockets, and proprietary APIs, enabling seamless data exchange between the local client network 12 and the third-party NLP computer system 14.

The gateway 20 is configured to enforce various security mechanisms, including data loss prevention (DLP) or other related, data integrity and security techniques known to those skilled in the art. For example, the gateway 20 includes a firewall and access control mechanisms, such as for intrusion prevention systems (IPS), network address translation (NAT), and secure web gateway (SWG) functions. Such data protection functions and techniques are used in a wide variety of settings and use cases, and are generally agnostic to the particular computer or device as well as the particular computer application that initiated the network request that is being evaluated for security by the gateway 20. Such generally-applicable data safeguarding techniques are not readily adaptable to specific computer applications, and their wide applicability results in curtailing efforts directed at addressing specific technologies and/or technical security gaps that may arise as a result of missing or not suitably safeguarding natural language or text contained within network requests to be sent out of the local client network 12. These widely-applicable safeguarding techniques mentioned in this paragraph are separate and different from those performed by the client-side NLP data safeguarding tool 22, at least according to the present embodiment.

The client-side NLP data safeguarding tool 22 is instantiated and put into use through execution of computer instructions at the local client network 12. Although the client-side NLP data safeguarding tool 22 is shown and described in the present embodiment as being executed by the client computer 18, in other embodiments, the client-side NLP data safeguarding tool 22 may be executed by another device of the local client network 12, such as the gateway 20, for example.

The client-side NLP data safeguarding tool 22 is a software tool and, in particular, is a “client-side” software tool installed in that the software tool is located and installed at the local client network 12. The client-side NLP data safeguarding tool 22 is for safeguarding data to be sent out of the local client network 12 by the client computer 18, such as via the gateway 20. The client-side NLP data safeguarding tool 22 is also referred to in the present embodiment as an “on-premise” or a “local” NLP data safeguarding tool in that the tool 22 is located at the same premises as the client computer 18 for which the tool 22 is configured to safeguard in terms of data being or to be sent out of the local client network 12.

The client-side NLP data safeguarding tool 22 is configured to safeguard data to be sent out of the local client network 12. In the present embodiment, the client-side NLP data safeguarding tool 22 is specifically configured to safeguard data sent or to be sent out by the client computer 18 and, namely in the present illustrated embodiment, for safeguarding information sent out or to be sent out of the local client network 12 by a host application 24 of the client computer 18.

With continued reference generally to FIG. 1, but now with particular reference to FIG. 2, there is shown the local client network 12, including the client computer 18 and the gateway 20. The client computer 18 includes a host application 28 and a safeguarding application 30, each of which is executed through respective computer instructions by the at least one processor 24. In the present embodiment, the client computer 18 includes an operating system 32 for facilitating execution of computer applications as well as managing hardware resources. In embodiments, the host application 28 is an internet or web browser, such as Google Chrome™ or Mozilla Firefox™, for example. As used herein, “web browser” or “browser” broadly covers all such browsers including internet browsers. And, in some of such embodiments, the safeguarding application 30 is a browser extension that is managed by the host application 28.

In the present embodiment, the operating system 32 of the client computer 18 is used for managing and enabling execution of computer applications on the client computer 18, such as, for example, the host application 28. In the present embodiment, the host application 28 is installed on the client computer 18 as a native computer application. As used herein, “native” or its other forms, when used in connection with a computer application, refers to the computer application being designed and developed to run specifically on a particular operating system or hardware platform. And, as used herein, “plugin” or “extension” refers to a non-native computer application.

The operating system 32 refers to system software used for accessing and managing hardware of the client computer 18, such as, for example, non-transitory, computer-readable memory (e.g., hard disk drive (HDD), solid state drive (SSD), read-only memory (ROM)). The operating system 32 may be Microsoft Windows™, Linux™, Android™, or MacOS™, for example. The operating system 32 of the present embodiment is used by the client computer 18 for managing execution of the host application 28 and other native computer applications, such as, for example, Microsoft Word™ or Google Chrome™.

In the present embodiment, the safeguarding application 30 is a browser extension that is configured to be executed and have its execution managed by the host application 28, which may be any of a variety of different browser extensions in the present embodiment. In other embodiments, the safeguarding application 30 is a Microsoft Office™ Add-in, such as, for example, a computer application that is configured for execution by Microsoft Office™ (as the host application 28 in such an embodiment). In another embodiment, the safeguarding application 30 is an integrated development environment (IDE) extension or plugin; for example, the host application 28 is an IDE (e.g., Eclipse™, Microsoft Visual Studio™ JetBrains IntelliJ IDEA™, PyCharm™) that manages the execution of the safeguarding application 30.

In at least one embodiment, an installation package or file for the host application 28 is downloaded using a browser extension of the client computer 18 and installed onto the client computer 18, such as, for example, through use of an installation wizard, executable file, or package manager. For example, an installation wizard or installer is downloaded from the internet and then launched by the operating system 32; here, the operating system 32 extracts and copies various files and data (e.g., dynamic linked libraries (dlls), other library files, media content, dependencies), as well as creates and/or updates registry information of the operating system 32.

In another embodiment, the host application 28 is a portable or containerized computer application, executing on the client computer 18 after having been downloaded or stored thereon and without having to perform an installation process. For example, in such an embodiment, the host application 28 is an executable (“exe”) file that includes all the needed files and information for executing on the operating system 32 without modifying registry information of the operating system 32. For example, a binary executable file (e.g., a “exe” file) is downloaded from a remote computer system and executed as the host application 28.

In at least one embodiment, the host application 28 is a platform-independent computer application that is executable by a virtual machine or interpreter. For example, in one embodiment, the host application 28 is either a Java™ application or Python™ application, and is executed by the client computer 18 using appropriate virtualization or interpretation software, such as through Python.exe or the Java Virtual Machine (JVM) installed on the operating system 32.

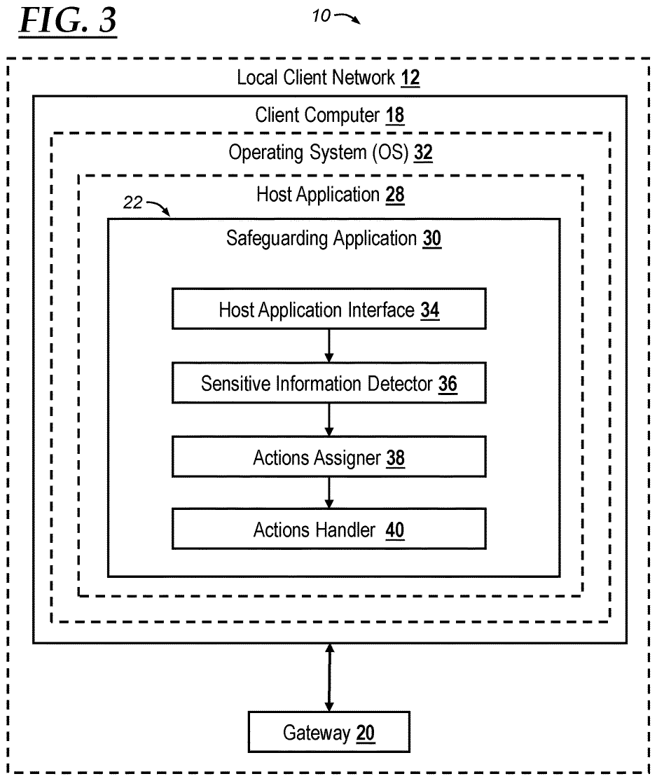

The exemplary embodiment of FIG. 2 depicts the local client network 12 as having a (virtual, networking) boundary defined by the gateway 20 in that devices located on one side (the “local” side) are physically or logically situated within an on-premise infrastructure, operating as part of a controlled network environment whereat the gateway 20 is located, whereas devices on the “remote” side, including the third-party NLP computer system 14, exist outside this boundary, requiring communication to pass through the gateway 20. In the present embodiment, the safeguarding application 30 is installed on the client computer 18. However, in other embodiments, the client-side NLP data safeguarding tool 22 is installed at the gateway 20 or other device of the local client network 12; in such embodiments, the client-side NLP data safeguarding tool 22 may be implemented as a safeguarding application installed on and executed by one or more local devices. The discussion herein, including that of FIG. 3 below, regarding the safeguarding application 30 is hereby incorporated and attributed to the client-side NLP data safeguarding tool 22 generally, including its other embodiments to the extent such discussion is not inconsistent with the discussion and teachings of those other embodiments.

With reference now to FIG. 3, there is shown an embodiment of the client-side NLP data safeguarding tool 22 as embodied by the safeguarding application 30, according to the present embodiment. The client-side NLP data safeguarding tool 22 is used for processing natural language model inputs to be sent out of the local client network 12, such as to a third party for NLP, such as, for example, text generation or classification to be performed by the third party NLP computer system 14. The client-side NLP data safeguarding tool 22 is implemented as a software extension of the host application 28 and is referred to as the safeguarding application 30. In the present embodiment, the safeguarding application 30 is described being a daemon-like application in that the safeguarding application 30 executes in a daemon-like fashion relative to the native computer application (the host application 28), meaning that, when the native computer or host application 28 is terminated, the safeguarding application 30 (and, at least in embodiments, the client-side NLP data safeguarding tool 22) are terminated.

However, it will be appreciated that the safeguarding application 30 may be implemented as a native or standalone computer application, at least in some embodiments and as discussed above. Furthermore, while software modules 34-40 are described in the present embodiment as being implemented as a part of the safeguarding application 30, which is described as a browser extension in the exemplary embodiment, such modules 34-40 may be implemented as a part of another computer application of the client computer 18 or device of the local client network 12, such as, for example, another client computer or server, the gateway 20, etc.

The software modules 34-40 of the safeguarding tool 22 are each described herein as having particular functionality attributed therewith and such functionality is effected through execution of corresponding computer instructions (that are stored on the memory 26) by the at least one processor 24. The software modules 34-40 include a host application interface 34 for communicating with the host application 28, a sensitive information detector 36 for detecting (potentially) sensitive information contained within natural language model inputs provided by or otherwise obtained from the host application 28, an actions assigner 38 for assigning an action to sensitive information detected within a natural language model input, and an actions handler 40 for causing execution of the assigned action, which may be any of a number of predetermined actions, such as, for example, replacing the sensitive information as originally presented in the natural language model input as obtained by the safeguarding application 30 with a safeguarded version of that sensitive information so that the natural language model input as modified no longer conveys or otherwise includes such sensitive information.

The host application interface 34 is a software or programming interface that allows the safeguarding application 30 to obtain a natural language model input from the host application 28. The host application interface 34 is used for accessing or otherwise obtaining a natural language model input that is from the host application 28. For example, in an embodiment where the host application 28 is a browser and the safeguarding application 30 is a plugin or extension for the browser, the host application 28 allows the safeguarding application 30 (and other extensions that may be installed thereon) to access certain data or aspects of or within the browser, such as, for example, local storage, html or web pages presently opened, remote domains/networks, etc. In continuing this example, the safeguarding application 30 may have permissions to access certain webpages and, based on detecting certain webpages, may identify portions of the webpage corresponding to textual input components having text input by a user; and, in another embodiment, and still within the context of the present example, the safeguarding application 30 has permissions to access network calls initiated or to be initiated by the browser at the request of a webpage, the browser itself, or another browser extension. Thus, the host application interface 34 is used by the safeguarding application 30 to access or otherwise obtain the natural language model input in its original or initial state before being desensitized.

As used herein, the term “desensitized” and its related forms, when used in connection with a natural language model input (e.g., a “desensitized natural language model input”), refers to the natural language model input having been modified so as to have sensitive information therein obfuscated, removed, or otherwise changed so as to not convey or otherwise include the sensitive information; and, as used herein, “unsensitized” or “original” and their related terms, when used in connection with a natural language model input (e.g., an “unsensitized natural language model input”, an “original natural language model input”) of a computer application that is to be sent out for processing, refers to the natural language model input in its initial state as generated and/or otherwise obtained from the computer application, including prior to any desensitization or modification of information contained, conveyed by, or otherwise included in the natural language model input. For example, if the host application 28 generates a first natural language model input having ten informational data items (e.g., ten pairs each consisting of an individual person and their social security number (SSN)), and then the safeguarding application 30 obtains and replaces the names and certain digits with placeholder/obfuscation values to generate a modified version of the natural language model input, the version prior to modification by the safeguarding application 30 is considered the “original natural language model input” and the modified version of the natural language model input is considered “desensitized natural language model input” in this example with each of the ten informational data items being a desensitized data item or, more particularly, a desensitized natural language model input data item.

The sensitive information detector 36 is configured to detect sensitive information contained within a natural language model input. The sensitive information detector 36 detects the presence of sensitive information within a natural language model input as well as the location or portion of the natural language model input corresponding to the sensitive information. According to embodiments, the sensitive information detector 36 may use any of a variety of techniques for detecting sensitive information, and this detection may be tailored specifically to the particular use case in which the sensitive information detector 36 will be used.

In general, this sensitive information detection is performed through use of rule or logic based detection and/or through ML/AI models or other context-inferring techniques. In regard to the rule/logic based detection techniques, detection is performed through assessing the syntax or makeup of the particular characters that form the natural language model input, such as, for example, assessing whether predetermined keywords or codes are within the natural language model input, detecting patterns through presence and/or position of particular characters, etc. As used herein, the term “syntactical”, when used in connection with sensitive information detection, refers to detection of sensitive information through the use of rule or logic based pattern matching, which includes, for example, regular expressions (regex), keyword-based detection for recognizing specific words or phrases (e.g., “Confidential,” “Credit Card Number”) or for performing checksum validations, and structural rules, such as for detection based on certain formats. It is noted that regex may be used for keyword-based detection and structural rules, but that such other techniques not specifically using regular expressions may be used for such detection, as will be appreciated by those skilled in the art.

On the other hand, other techniques such as inferential NLP techniques may be used for sensitive information detection, which may be useful, at least in some embodiments, for inferring a context surrounding or pertaining to the natural language model input in order to assess whether information contained therein is to be considered (detected) as sensitive information. As used herein, the term “contextual”, when used in connection with sensitive information detection, refers to detection of sensitive information as a result of assessing a context of the natural language model input, which includes, for example, inference by an NLP model (e.g., a ML model trained for sensitive information detection, such as where the ML model is trained for classifying an intent of sharing the natural language model input).

In embodiments, the sensitive information detector 36 is configured to implement a multifaceted detection framework in which both syntactical sensitive information detection and contextual sensitive information detection are performed for the natural language model input in order to detect sensitive information therein. An example of such a multifaceted detection framework having both syntactical and contextual sensitive information detection is shown and discussed below.

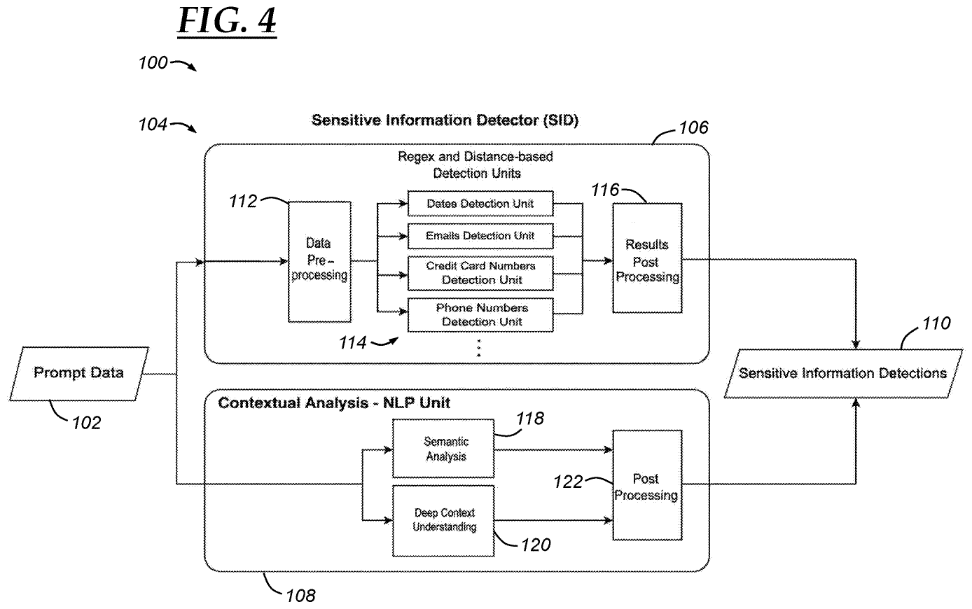

With reference now to FIG. 4, there is shown an exemplary sensitive information detector 100, and this sensitive information detector 100 is, according to one embodiment, used as the sensitive information detector 36 of FIG. 3. The sensitive information detector 100 is configured to detect sensitive information contained within a natural language model input 102 through use of a multifaceted detection framework 104 that is comprised of a syntactical sensitive information detector 106 and a contextual sensitive information detector 108. Each of these sensitive information detectors 106, 108 generates an output, referred to as a syntactical sensitive information detection output and a contextual sensitive information detection output, respectively. These outputs may be aggregated and/or otherwise used as or for determining the output of the sensitive information detector 100, as shown at 110.

The syntactical sensitive information detector 106 includes a data preprocessing phase 112, a detection process or phase 114, and a results postprocessing phase 116. In embodiments, the sensitive information detector. The syntactical sensitive information detector 106, according to one embodiment, contains independent units responsible for detecting specific sensitive information types, such as those set forth in the table below:

TABLE 1

| Detection Unit | | |
|---|---|---|
| Name | Description | Regex Pattern |
| Social Security | Detects U.S. Social | /(\d)*\d{3}([ -! @#$%∧&*( ){ }\s]{1,100})\d{2}([- |
| Numbers | Security Numbers | !@#$%∧&*( ){ }\s]{1,100})\d{4}( ?! \d)/gi |
| Detection (SSND) | (SSNs) | |
| Dates Detection | Detects both named and | ∧b(?:Sunday\|Monday\| ... \|Dec)\b/gi∧d+([-\∧s]*\d+)*/gi |
| (DD) | numerical dates in the | |
| | prompt data | |
| Emails Detection | Identifies email | /([a-zA-Z0-9._ %-]+@[a-zA-Z0-9 .- ]+\.[a-zA-Z |
| (ED) | addresses within prompt | }{2,6})/gi |
| | data | |
| Credit Card | Detects potential credit | ∧b(?:\d[ -!@#$%∧&*( ){ }\s]*){14,16}\b/gi |
| Numbers | card numbers | |
| Detection (CCND) | | |
| Phone Numbers | Detects American phone | ∧b(?:\+?1\s*[ -.\∨]?\s*)?(?:\d{3}\)\|\d{3})\s*[- |
| Detection (PND) | numbers | .\∨]?\s*\d{3}\s*[-.\∨]?\s*\d{4}b/gi |
| American | Identifies potential | ∧d+\s+[a-zA- |
| Addresses | American addresses | Z]+\s+(Street\|St\|Avenue\|Ave\|Boulevard\|Blvd\|Road\|Rd\| |
| Detection (AAD) | within prompt data | Drive\|Dr\|Court\|Ct\|Lane\|Ln\|Way\|Wy\|Circle\|Cir\|Plaza\|Plz |
| | | )\,?\s+[a-zA-Z]+\s*,\s*[A-Z]{2}\s*\d{5}(?:-\d{4})?/gi |
| IBAN Detection | Detects International | ∧b[A-Z]{2}\s*\d{2}\s*[A-Z0-9\s]{11,30}\b/g |
| (IBAND) | Bank Account Numbers | |
| | (IBANs) | |
| Alphanumeric and | Detects alphanumeric | Alphanumeric: |
| Numeric Values | sequences representing | ∧b[a-zA-Z0-9 _- ]{5,20}\b/ |
| Detection (ANVD) | sensitive identifiers such | Numeric: |
| | as usernames, personal | ∧b\d+(\.\d+)?\b/ |
| | IDs, driving license | |
| | numbers, etc. | |
| URL Detection | Identifies URLs | ∧b(https?:∨∨\|\|www\.)?[a-zA-Z0-9-]+(\.[a-zA-Z |
| (URLD) | | }{2,})(∨[a-zA-Z0-9#?&% =_. +-]*)?\b(?!@)/gi |
| Code Snippets | Detects programming | Variable Assignment: |
| Detection (CSD) | code snippets embedded | /[a-zA-Z_]\w*\s*=\s*[∧=\n]+/ |
| | within the prompt data | Python function: |
| | | /def\s+[a-zA-Z_]\w*\s*\(.*\)\s*:/ |
| | | If statements: |
| | | /if\s*\(.*\)\s*{/ |

Each detector function within the SID utilizes regex patterns and logical checks to identify sensitive data. Below each function is described, including its inputs, outputs, and detailed step-by-step operations.

In some embodiments, in addition to using regular expressions or other pattern matching technique(s) to identify sensitive information, other parameters and/or aspects of the natural language model input and/or information derived therefrom (e.g., an output of the regular expressions indicating zero or more matches and, in a case of a positive detection, one or more matches), such as, for example, frequency or count information indicating a threshold number of matches and, as another example, a character distance threshold indicating an integer number of characters between a detected match and a keyword within the natural language model input, as will be described in more detail in the following paragraphs.

The following paragraphs set forth technology describing aspects of a client-side NLP data safeguarding tool. According to the present embodiment, the NLP data safeguarding tool empowers organizations to maintain on-premises control over their data privacy while benefiting from the performance and capabilities of cloud-based generative AI. Further, in this embodiment, this technology eliminates reliance on trusting the generative AI provider on how they will handle the organization's sensitive data in addition to how employees might misuse the technology, as the organization has visibility and control over what information can be sent to the generative AI model and whether or not such information should be masked. Also, in the present embodiment, the NLP data safeguarding tool empowers its users to utilize cloud generative AI benefits such as performance, flexibility, and scalability while maintaining on-premises control over data privacy and security. Furthermore, in embodiments, the NLP data safeguarding tool effectively eliminates the negative aspects of on-premises generative AI models (rigidity, updates frequency, scalability issues) while still maintaining its positive aspects of ownership that is not reliant on trust (whether contractual, reputational, or internal misuse).

According to embodiments, the NLP data safeguarding tool includes the sensitive information detector 36, the actions assigner 38, and the actions handler 40. Before the prompt data is exposed to the network outside the user's machine or submitted/sent to the LLM, the NLP data safeguarding tool takes the prompt to analyze and decide whether to: (1) block the prompt from being submitted/sent to the LLM. In this case, the prompt will remain only on the user's machine; (2) warn the user about sensitive information found; and (3) mask the sensitive information parts. In regards to (2), in this case, the NLP data safeguarding tool warns the user and gives two options: accept or decline the submission. If the user accepts, the prompt will be sent/submitted through the network to the LLM. If the user declines, the prompt will remain only on the user machine, and the submission will be blocked. In regards to (3), the NLP data safeguarding tool masks the sensitive information parts by replacing them with characters, numbers, or symbols in a way that preserves the prompt's meaning and context without having sensitive information.

Referring back to FIG. 4, the sensitive information detector 100 executes the regular expressions to identify one or more matches, such as through executing a dates detection unit (see DD in Table 1), an emails detection unit (see ED in Table 1), a credit card numbers detection unit (see CCND in Table 1), and a phone numbers detection unit (see PND in Table 1). The syntactical sensitive information detector 106 uses these predefined patterns or regular expression statements to perform textual pattern matching. In particular, the textual pattern matching performed by the syntactical sensitive information detector 106 in the present embodiment is illustrated as including at least four regular expressions each in a corresponding “Detection Unit” as illustrated in FIG. 4. However, of course, in other embodiments, any of a variety of different predefined patterns may be determined and used for textual pattern matching as part of the syntactical sensitive information detector 106.

In addition, in some embodiments, the syntactical sensitive information detector 106 identifies a text string within the natural language model input through use of a predefined text pattern, such as, for example, any one or combination of those examples in Table 1. Then, the syntactical sensitive information detector 106 determines distance information indicating a character distance between the text string and a keyword, such as is described below in connection with the social security number detection function and other like examples. Then, in such embodiments, a detection result may be determined based on the character distance, such as through comparing the character distance to a predefined threshold, as described, such as is described below in connection with the social security number detection function and other like examples.

Examples of the syntactical sensitive information detector 106 include: a social security number (SSN) detection function (also referred to as an “SSN detector” or “SSND”); a dates detection function (also referred to as a “dates detector” and “DD”); an email detection function (also referred to as an “email detector” and “ED”); a credit card number detection function (also referred to as a “CC number detector” and “CCND”); a phone number detection function (also referred to as a “phone number detector” and “PND”); an American address detection function (also referred to as an “AA detector” and “AAD”); an international bank account number (IBAN) detection function (also referred to as an “IBAN detector” and “IBAND”); a uniform resource locator (URL) detection function (also referred to as a “URL detector” and “URLD”); a code snippet detection function (also referred to as a “code snippet detector” and “CSD”); and an alphanumeric and numeric values detection function (also referred to as an “alphanumeric values detector” and “ANVD”).

In regards to the SSN detector, the purpose is to detect SSNs in text using regex patterns and/or proximity checks with related keywords. For example, the input into the SSN detector may include: text_prompt (a string of the input text to search for the SSNs); distance_threshold (an integer specifying the maximum allowed distance between the keyword and regex match); and frequency (an integer specifying the minimum count of matches needed to return a positive detection). Also, in embodiments, the output of the SSN detector may be: detected_ssns (a list of detected SSNs or an empty list if the count is below the frequency threshold).

In regards to the operation of the SSN detector, the following steps may be used: (SSN-1) define regex patterns; (SSN-2) match patterns with the text; (SSN-3) calculate distances between matches and keywords; (SSN-4) sort and count distances below the threshold; and (SSN-5) make a detection decision. In regards to (SSN-1), regular expressions are defined in order to identify potential SSNs within the text. An example of an SSN detection regex is:
(\d)*\d{3}([−!@#$%\hat{ }&*( ){ }\s]{1,100})\d{2}([−!@#$%\hat{ }&*( ){ }\s]{1,100})\d{4}(?!\d)/gi
   In regards to (SSN-2), all matches using the regex pattern are extracted: Matches={M₁, M₂, . . . , Mₙ} where n is the number of regex matches found. In regards to (SSN-3), for each match Mᵢ and keyword Kⱼ, a distance Dᵢⱼ is calculated and is defined as the number of tokens between the keyword Kⱼ and the regex match Mᵢ: Dᵢⱼ=TokenCount(Kⱼ, Mᵢ). The distance matrix may be constructed as:

$$Distance Matrix = [ \begin{matrix}{D}_{00} & {D}_{01} & … & {D}_{0 m} \\ {D}_{10} & {D}_{11} & … & {D}_{1 m} \\ ⋮ & ⋮ & ⋱ & ⋮ \\ {D}_{n 0} & {D}_{n 1} & … & {D}_{nm}\end{matrix} ]$$

In regards to (SSN-4), the distances Dᵢⱼ less than the distance_threshold are counted:

$$Count = {\sum }_{i = 0}^{n} {\sum }_{j = 0}^{m} 1 ( {D}_{ij} < distance\_threshold )$$

where 1(·) is an indicator function. In regards to (SSN-5), a list of matches is returned if the count is above the frequency threshold:

$$detected\_ssns = \{ \begin{matrix}\{ {M}_{1} , {M}_{2} , … , {M}_{n} \} , & if Count \geq frequency \\ ∅ , & otherwise\end{matrix}$$

In regards to the dates detector, the purpose is to detect date formats including day/month names and numerical dates within the text. For example, the input into the dates detector may include: text_prompt (a string of the input text to search for date patterns); distance_threshold (an integer specifying the maximum allowed distance between relevant keywords and the detected date); and frequency (an integer specifying the minimum count of matches needed to return a positive detection). Also, in embodiments, the output of the dates detector may be: detected_dates (a list of detected dates or an empty list if the count is below the frequency threshold).

In regards to the operation of the dates detector, the following steps may be used: (DATE-1) define regex patterns; (DATE-2) match patterns with the text; (DATE-3) clean and filter numerical dates; (DATE-4) count matches; and (DATE-5) make a detection decision. In regards to (DATE-1), regular expressions are defined in order to identify full and/or abbreviated day and month names and numerical date formats within the text. An example of a dates detection regex is:
∨b(?:Sunday|Monday| . . . |Dec)\b/gi∧d+([−\∧s]*\d+)*/gi
   where “ . . . ” can include the days of the week and the months of the year. In regards to (DATE-2), all matches using the regex pattern are extracted: Matches={M₁, M₂, . . . , Mₙ} where n is the number of regex matches found. In regards to (DATE-3), whitespace is removed and data structures are validated. For example, a match Mᵢ is valid if:
Mᵢ=Mᵢ. replace(\s,″) if |Mᵢ|≥8 and (‘/’ or ‘-’)
   In regards to (DATE-4), it is determined whether the number of detected matches exceeds the frequency threshold:

$$Count = {\sum }_{i = 1}^{n} 1 ( Valid ( {M}_{i} ) )$$

In regards to (DATE-5), a list of matches is returned if the count is above the frequency threshold:

$$detected\_dates = \{ \begin{matrix}\{ {M}_{1} , {M}_{2} , … , {M}_{n} \} , & if Count \geq frequency \\ ∅ , & otherwise\end{matrix}$$

In regards to the email detector, the purpose is to identify email addresses within the text. For example, the input into the email detector may include: text_prompt (a string of the input text to search for email addresses); distance_threshold (an integer specifying the maximum allowed distance between relevant keywords and detected emails); and frequency (an integer specifying the minimum count of matches needed to return a positive detection). Also, in embodiments, the output of the email detector may be: detected_emails (a list of detected emails or an empty list if the count is below the frequency threshold).

In regards to the operation of the email detector, the following steps may be used: (EMAIL-1) define regex patterns; (EMAIL-2) match patterns with the text; (EMAIL-3) count matches; and (EMAIL-4) make a detection decision. In regards to (EMAIL-1), regular expressions are defined in order to detect standard email formats within the text. An example of an email detection regex is:
/([a-zA-Z0-9._%−]+@[a-zA-Z0-9.−]+\.[a-zA-Z]{2,6})/gi
   In regards to (EMAIL-2), all matches using the regex pattern are extracted: Matches={E₁, E₂, . . . , E} where n is the number of regex matches found. In regards to (EMAIL-3), it is determined whether the number of detected matches exceeds the frequency threshold:

$$Count = {\sum }_{i = 1}^{n} 1 ( Valid ( {E}_{i} ) )$$

In regards to (EMAIL-4), a list of matches is returned if the count is above the frequency threshold:

$$detected\_emails = \{ \begin{matrix}\{ {E}_{1} , {E}_{2} , … , {E}_{n} \} , & if Count \geq frequency \\ ∅ , & otherwise\end{matrix}$$

In regards to the CC number detector, the purpose is to detect sequences resembling credit card numbers within the text. For example, the input into the CC number detector may include: text_prompt (a string of the input text to search for credit card numbers); distance_threshold (an integer specifying the maximum allowed distance between relevant keywords and detected numbers); and frequency (an integer specifying the minimum count of matches needed to return a positive detection). Also, in embodiments, the output of the CC number detector may be: detected_credit_cards (a list of detected credit card numbers or an empty list if the count is below the frequency threshold).

In regards to the operation of the CC number detector, the following steps may be used: (CCND-1) define regex patterns; (CCND-2) match patterns with the text; (CCND-3) count matches; and (CCND-4) make a detection decision. In regards to (CCND-1), regular expressions are defined in order to detect credit card numbers within the text. An example of a CC number detection regex is:
∧b(?:\d[−!@#$%\hat{ }&*({ }\s]*){14,16}\b/gi
   In regards to (CCND-2), all matches using the regex pattern are extracted: Matches={C₁, C₂, . . . , Cₙ} where n is the number of regex matches found. In regards to (CCND-3), the number of credit card detections is verified by checking the extracted numbers against typical credit card number structures:

$$Count = {\sum }_{i = 1}^{n} 1 ( Valid ( {C}_{i} ) )$$

In regards to (CCND-4), a list of matches is returned if the count is above the frequency threshold:

$$detected\_credit \_cards = \{ \begin{matrix}\{ {C}_{1} , {C}_{2} , … , {C}_{n} \} , & if Count \geq frequency \\ ∅ , & otherwise\end{matrix}$$

In regards to the phone number detector, the purpose is to detect phone numbers, including various formatting styles and optional country codes, within the text. For example, the input into the phone number detector may include: text_prompt (a string of the input text to search for phone numbers); distance_threshold (an integer specifying the maximum allowed distance between relevant keywords and detected phone numbers); and frequency (an integer specifying the minimum count of matches needed to return a positive detection). Also, in embodiments, the output of the phone number detector may be: detected_phones (a list of detected phone numbers or an empty list if the count is below the frequency threshold).

In regards to the operation of the phone number detector, the following steps may be used: (PND-1) define regex patterns; (PND-2) match patterns with the text; (PND-3) count valid matches; and (PND-4) make a detection decision. In regards to (PND-1), regular expressions are defined in order to detect phone number formats, including optional country codes, within the text. An example of a phone number detection regex is:
∧b(?:\+?1\s*[−.\∨]?\s*)?(?:\(d{3}\)|\d{3})\s*[−.\∨]?\s*\d{3}\s*[−.\∧]?\s*\d{4}\b/gi
   In regards to (PND-2), all matches using the regex pattern are extracted: Matches={P₁, P₂, . . . , Pn} where n is the number of regex matches found. In regards to (PND-3), it is ensured that the detected phone numbers are formatted correctly and within proximity constraints:

$$Count = {\sum }_{i = 1}^{n} 1 ( Valid ( {P}_{i} ) )$$

In regards to (PND-4), a list of matches is returned if the count is above the frequency threshold:

$$detected\_phones = \{ \begin{matrix}\{ {P}_{1} , {P}_{2} , … , {P}_{n} \} , & if Count \geq frequency \\ ∅ , & otherwise\end{matrix}$$

In regards to the AA detector, the purpose is to detect identify American-style addresses within the text. In other embodiments, other types of addresses, such as those of other countries (e.g., France, Germany), may be identified and configured as a part of a country-specific detector; further, it will be appreciated that the following description of the AA detector may be modified, such as through modifying the AA detector regex, according to the type of address (e.g., France addresses, German addresses) for which the detector is to be used. For the AA detector, for example, the input into the AA detector may include: text_prompt (a string of the input text to search for American addresses); distance_threshold (an integer specifying the maximum allowed distance between relevant keywords and detected addresses); and frequency (an integer specifying the minimum count of matches needed to return a positive detection). Also, in embodiments, the output of the AA detector may be: detected_addresses (a list of detected addresses or an empty list if the count is below the frequency threshold).

In regards to the operation of the AA detector, the following steps may be used: (AAD-1) define regex patterns; (AAD-2) match patterns with the text; (AAD-3) count valid matches; and (AAD-4) make a detection decision. In regards to (AAD-1), regular expressions are defined in order to detect common American address formats, including street names and ZIP codes, within the text. An example of an American address detection regex is:
∧d+s+[a-zA-Z]+s+(Street|St|Avenue|Ave|Boulevard|Blvd|Road|Rd|Drive|Dr|Co urt|Ct|Lane|Ln|WaylWyICircle|Cir|PlazalPlz),?s+[a-zA-Z]+s*,s*[A-Z]{2}s*d{5}(?:−d{4})?/gi
   In regards to (AAD-2), all matches using the regex pattern are extracted: Matches={A₁, A₂, . . . , Aₙ} where n is the number of regex matches found. In regards to (AAD-3), the matches are verified based on recognized formats and proximity to relevant keywords:

$$Count = {\sum }_{i = 1}^{n} 1 ( Valid ( {A}_{i} ) )$$

In regards to (AAD-4), a list of matches is returned if the count is above the frequency threshold:

$$detected\_addresses = \{ \begin{matrix}\{ {A}_{1} , {A}_{2} , … , {A}_{n} \} , & if Count \geq frequency \\ ∅ , & otherwise\end{matrix}$$

In regards to the IBAN detector, the purpose is to detect IBANs within the text ensure proximity to relevant keywords. For example, the input into the IBAN detector may include: text_prompt (a string of the input text to search for the IBANs); distance_threshold (an integer specifying the maximum allowed distance between the keyword and regex match); and frequency (an integer specifying the minimum count of matches needed to return a positive detection). Also, in embodiments, the output of the IBAN detector may be: detected_ibans (a list of detected IBANs or an empty list if the count is below the frequency threshold).

In regards to the operation of the IBAN detector, the following steps may be used: (IBAN-1) define regex patterns; (IBAN-2) match patterns with the text; (IBAN-3) calculate distances between matches and keywords; and (IBAN-4) make a detection decision. In regards to (IBAN-1), regular expressions are defined in order to identify potential IBAN formats within the text. An example of an IBAN detection regex is:
∧b[A-Z]{2}\s*\d{2}\s*[A-Z0-9\s]{11,30}\b/g
   In regards to (IBAN-2), all matches using the regex pattern are extracted: Matches={I₁, I₂, . . . , Iₙ} where n is the number of regex matches found. In regards to (IBAN-3), the proximity to relevant keywords is determined and the valid IBANs within the specified distance threshold is calculated. In embodiments, for each match Iᵢ and keyword Kⱼ, a distance Dᵢⱼ is calculated and is defined as the number of tokens between the keyword Kⱼ and the regex match Iⱼ: Dᵢⱼ=TokenCount(Kⱼ, Iⱼ). The distance matrix may be constructed as above with respect to the SSN detector.

$$Count = {\sum }_{i = 1}^{n} 1 ( {D}_{ij} < distance\_threshold )$$

where 1(·) is an indicator function. In regards to (IBAN-4), a list of matches is returned if the count is above the frequency threshold:

$$detected\_ibans = \{ \begin{matrix}\{ {I}_{1} , {I}_{2} , … , {I}_{n} \} , & if Count \geq frequency \\ ∅ , & otherwise\end{matrix}$$

In regards to the URL detector, the purpose is to detect URLs within the text. For example, the input into the URL detector may include: text_prompt (a string of the input text to search for URLs); distance_threshold (an integer specifying the maximum allowed distance between relevant keywords and the detected URLs); and frequency (an integer specifying the minimum count of matches needed to return a positive detection). Also, in embodiments, the output of the URL detector may be: detected_urls (a list of detected URLs or an empty list if the count is below the frequency threshold).

In regards to the operation of the URL detector, the following steps may be used: (URL-1) define regex patterns; (URL-2) match patterns with the text; (URL-3) validate URLs; (URL-4) count valid matches; and (URL-5) make a detection decision. In regards to (URL-1), regular expressions are defined in order to match standard URL structures within the text. An example of a URL detection regex is:
∧b(https?:∨∨//www\.)?[a-zA-Z0-9-]+(\. [a-zA-Z]{2,})(∨[a-zA-Z0-9#?&%=_.+−]*)?\b(?!@)/gi
   In regards to (URL-2), all matches using the regex pattern are extracted: Matches={U₁, U₂, . . . , Uₙ} where n is the number of regex matches found. In regards to (URL-3), the matches are valid, such as, for example, using a validateURL function that ensures the URLs do not contain disallowed characters (e.g., “@”). In regards to (URL-4), it is determined whether the number of detected matches exceeds the frequency threshold:

$$Count = {\sum }_{i = 1}^{n} 1 ( Valid ( {U}_{i} ) )$$

In regards to (URL-5), a list of matches is returned if the count is above the frequency threshold:

$$detected\_urls = \{ \begin{matrix}\{ {U}_{1} , {U}_{2} , … , {U}_{n} \} , & if Count \geq frequency \\ ∅ , & otherwise\end{matrix}$$

In regards to the code snippet detector, the purpose is to identify code snippets written in various programming languages within the text. For example, the input into the code snippet detector may include: text_prompt (a string of the input text to search for code snippets). In other embodiments, one or more other inputs may be used, such as, for example, those inputs discussed in connection with the other detectors (e.g., SSN detector). Also, in embodiments, the output of the code snippet detector may be: detected_code_snippets (a list of detected code snippets or an empty list if no code is detected).

In regards to the operation of the code snippet detector, the following steps may be used: (CSD-1) define regex patterns; (CSD-2) match patterns with the text; and (CSD-3) make a detection decision. In regards to (CSD-1), regular expressions are defined in order to detect common programming constructs (e.g., variable assignments, function definitions, and loops) within the text. Examples of a code snippet detection regex include:
/[a-zA-Z_]\w*\s*=\s*[\hat{ }=\n]+/[for variable assignments]
/def\s+[a-zA-Z_]\w*\s*\(.*\)s*:/[for Python function definitions]
/if\s*\(.*\)s*{/[for If statements]
   In regards to (CSD-2), all matches using the regex pattern are extracted: Matches={C₁, C₂, . . . , Cₙ} where n is the number of regex matches found. In regards to (CSD-3), a list of detected code snippets is returned:

$$detected\_code \_snippets = \{ \begin{matrix}\{ {C}_{1} , {C}_{2} , … , {C}_{n} \} , & if n > 0 \\ ∅ , & otherwise\end{matrix}$$

After the individual detection unit(s) return a result, a postprocessing phase 116 is performed. In the postprocessing phase 116, result(s) from the detections made in the detection phase 114 are processed, such as, for example, where detection results are configured based on conditions requiring information (e.g., a detection output) from more than one detector, such as from two or more of the four detectors shown in the detector phase 114 in FIG. 4, for example.

The contextual sensitive information detector 108 is used for detecting sensitive information using NLP-based inference or processing whereby a trained NLP model, such as a trained ML model, is used for detecting sensitive information. In embodiments, the NLP data safeguarding tool includes an exemplary contextual sensitive information detector, referred to in this particular embodiment as an NLP-based Contextual Analysis Unit (NCAU). An embodiment of the NCAU is described in the following paragraphs and serves as an example of the contextual sensitive information detector 108.

The NCAU is responsible for detecting sensitive information using advanced natural language processing techniques. Unlike the RDDUs, which rely on pattern matching and distance-based detection, the NCAU leverages deep context understanding and semantic analysis to be capable of detecting if specific concepts and intents—based on the user preference—are found in the prompt data. The NCAU of the present embodiment includes two components: (1) Deep Context Understanding Unit; and (2) Semantic Analysis Unit.

The Deep Context Understanding Unit utilizes contextual clues and advanced NLP techniques to determine the meaning behind a prompt, differentiating between benign mentions of sensitive information (e.g., discussing security practices) and potentially harmful disclosures. In the present embodiment, the Deep Context Understanding Unit detects and evaluates the surrounding context of potentially sensitive information within a prompt using advanced NLP methods. According to the present embodiment, the input of the Deep Context Understanding Unit is: text prompt (a string of the input text to be analyzed for contextual clues); and a context threshold (an integer, such as a predetermined integer, that is the minimum context depth required to confirm sensitive use). In the present embodiment, the output of the Deep Context Understanding Unit is a contextual classification, which is a string indicating a classification of the input as benign or harmful.

In regards to the operation of the Deep Context Understanding Unit, in the present embodiment, the Deep Context Understanding Unit performs four operations: (1) a tokenize and parse prompt operation where the input text is tokenized to identify key phrases and entities; (2) a contextual clue extraction operation where the context surrounding sensitive terms is analyzed using NLP models to assess intent; (3) a determine contextual sensitivity operation where the prompt is classified as benign or harmful based on the contextual information; and (4) a return classification operation where the final contextual classification, either marking it as a safe discussion or potentially harmful disclosure, is output.

The Semantic Analysis Unit is responsible for performing a semantic evaluation of the entire prompt, this unit detects subtle nuances, interprets the intent, and analyzes the overall meaning behind the use of sensitive terms. In the present embodiment, the Semantic Analysis Unit is configured to analyze the overall semantics of the text to infer the intent behind sharing sensitive information. According to the present embodiment, the input of the Semantic Analysis Unit is: text prompt (a string of the input text on which the semantic analysis is performed); and intent_threshold (an integer, such as a predefined integer, that is the minimum confidence level to confirm malicious intent). In the present embodiment, the output of the Semantic Analysis Unit is an intent classification, which is a string indicating a classification of the inferred intent as benign or malicious.

In regards to the operation of the Semantic Analysis Unit, in the present embodiment, the Semantic Analysis Unit performs four operations: (1) a semantic parsing operation where deep semantic analysis of the text is performed to capture subtle nuances; (2) an intent inference operation where NLP models are used to infer the underlying intent behind the use of sensitive information; (3) an evaluate intent confidence operation where a confidence score for the inferred intent is calculated based on semantic patterns; and (4) a return intent classification operation where the final intent classification, marking it as either benign or malicious, is output.

The contextual sensitive information detector 108 includes a semantic analyzer 118 and a deep context understanding extractor 120, as illustrated in FIG. 4. The semantic analyzer 118 is used for performing a semantic evaluation of the natural language model input and, in embodiments, for evaluating the entire natural language model input as a whole in order to, for example, detect subtle nuances, classify intent, and analyze the overall meaning behind the use of sensitive terms or messages.

The semantic analyzer 118 is used for analyzing the overall semantics or meaning of the text in order to infer the intent behind sharing sensitive information via the natural language model input 102. For example, as described in the present exemplary embodiment, the Semantic Analysis Unit (which is an example of the semantic analyzer 118) inputs include the text_prompt (the natural language model input) and an intent threshold, which is a minimum confidence level that is attributed to malicious intent, and with the output being a classification of whether the intent is believed to be malicious (harmful) or not (benign). In embodiments, the semantic analyzer 118 performs semantic parsing to capture subtle nuances; for example, such as ‘for our collaborative project,’ or if it contains language indicative of concealment, such as ‘make sure no one else sees this.’ Also, in embodiments, the intent is determined using an NLP model that is trained to infer an underlying intent behind the natural language input. Also, in embodiments, the intent is determined using an NLP model that is trained to infer an underlying intent behind the natural language model input.

The deep context understanding extractor 120 is used for detecting and evaluating the surrounding context of sensitive information within the natural language model input 102. For example, the Deep Context Understanding Unit (which is an example of the deep context understanding extractor 120) inputs include the text_prompt (the natural language model input) and a context threshold, which is a minimum context depth required to confirm sensitive use/presence of sensitive information, and with the output being a classification of the natural language model input 102 as being malicious (harmful) or not (benign).

The intent is determined using an NLP model that is trained to infer an underlying intent behind the natural language model input. The NLP model may be a neural network that is trained for such a purpose. In embodiments, the NLP model is used for tokenizing characters or strings of the natural language model input 102 in order to generate tokenized input data; here, the tokenized input data may be used to indicate one or more key phrases or entities. Accordingly, at least according to some embodiments employing an NLP model, an output of the NLP model indicates an inferred aspect of the natural language model input, such as, for example, whether there is a benign or malicious intention behind the sharing of the natural language model input. Further, a confidence score for the inferred aspect of the natural language model input may be determined and then used for deciding whether to indicate a positive detection as a part of the output of the contextual sensitive information detection.

Outputs of the semantic analyzer 118 and the deep context understanding extractor 120 may be combined in the postprocessing phase 122 and provided as a final output for the contextual sensitive information detector 108.

With reference back to FIG. 3, the output of the sensitive information detector 36 is then input into the actions assigner 38 of the client-side NLP data safeguarding tool 22. The actions assigner 38 is used for assigning an action to sensitive information detected within the natural language model input. In embodiments, the actions assigner 38 is configured to analyze detected sensitive information from the sensitive information detector 36 and to assign each piece of sensitive information a predefined protective or defensive action (referred to as a “safeguarding action”).

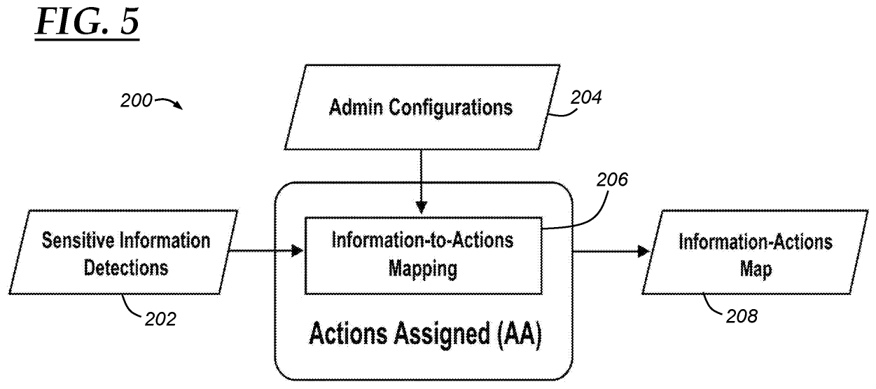

With reference now to FIG. 5, there is shown a process 200 of assigning a safeguarding action to sensitive information, and that may be used for determining a safeguarding action for each of one or more detected sensitive information items contained within the natural language model input. As used herein, a “sensitive information item” refers to a part of the natural language model input or other data constituting an instance of sensitive information, such as where a first SSN detected is a first sensitive information item, a second SSN detected for another individual is a second sensitive information item, and a telephone number is a third sensitive information item, for example. The actions assigner 200 includes receiving sensitive information detection data 202 as well as configuration data such as admin configurations 204, and then performing an information-to-actions mapping 206 in order to generate an information-actions map 208.

The process 200 and assignment of actions in general is described herein as having “a safeguarding action” and refers to “the safeguarding action”, at least in connection with some embodiments. Nonetheless, as taught herein, in embodiments, a plurality of safeguarding actions are determined for a single natural language model input, such as, for example, a single textual prompt to be input into a AI NLP model (e.g., ChatGPT™ model GPT 4o, other LLM model). Accordingly, the discussion of the safeguarding action, even when used in the singular form as is the case in this sentence, refers and applies equally to each of the plurality of safeguarding actions discussed herein to the extent such discussion is not inconsistent with the discussion of the plurality of safeguarding actions. For example, a statement stating or otherwise teaching that the safeguarding action is performed by the process 200 means that, in embodiments employing a plurality of safeguarding actions, each of the plurality of safeguarding actions is determined through use of the process 200, at least according to one embodiment.

In some embodiments, a single safeguarding action is determined for a plurality of detected sensitive information items. For example, in some instances, a single safeguarding action is suitable for addressing each of the detected safeguarding items within the natural language model input, such as, for example, where the safeguarding action is to prompt the user with a warning message that the natural language model input includes potentially sensitive information. Such a warning message may render the human user with enough of a realization for addressing each of the sensitive information items, thereby addressing all (or at least multiple) of the plurality of sensitive information items together in one fell swoop. In such embodiments, the process 200 and/or the actions assigner 38 (FIG. 3) is used for determining safeguarding action data for each sensitive information item detected within the natural language model input. The safeguarding action data may be aggregated or otherwise combined or considered together in order to determine one or more safeguarding actions. The safeguarding action data, thus, is determined for each of the sensitive information items even though, in some cases, this may result in the same set of datums (i.e., the same data) constituting the safeguarding action data for each of two or more sensitive information items, such as where the same safeguarding action is determined to be performed in the same manner in order to address the two or more sensitive information items. In the present embodiment of FIG. 5, the safeguarding action data for the identified sensitive information item(s) is constituted by the information-actions map 208, which is discussed in more detail below.

The safeguarding action data indicates at least one safeguarding action to be performed and, when used in connection with a sensitive data item of a natural language model input, indicates at least one safeguarding action to be performed for addressing the sensitive information item; and, here, at least in the present embodiment, the safeguarding action(s) indicated by the safeguarding action data are each an action that, when effected or otherwise put into effect, prevents or otherwise operates to prevent or inhibit unintentional or negligent (as well as malicious or bad-intentioned) release or conveyance of sensitive information (corresponding to the sensitive information item) to outside of the local client network 12. Thus, each safeguarding action operates, at least in the present embodiment, to prevent release or communication of a natural language model input having sensitive information without redaction, obfuscation, deletion, modification, or other modification or validation/approval by a human user.

As a first example, the safeguarding action is a “warn” type safeguarding action determined as a result of the process 200. The warn type safeguarding action refers to an action that causing a user to be prompted or otherwise informed that the natural language model input has (potentially) sensitive information contained therein. In embodiments, the warn type safeguarding action provides an option to accept or decline the submission of the natural language model input; here, the “option” refers to an inquiry to a human user, which, in an exemplary embodiment, is rendered in the form of a graphical interactive pushbutton presented on the client computer 18 as a part of a graphical user interface (GUI). As another example, the safeguarding action is a “mask” type safeguarding action determined as a result of the process 200. The mask type safeguarding action refers to an action that causes redacting, obfuscating, or otherwise masking sensitive information contained within the natural language model input prior to the natural language model input being sent out of the local client network 12 (which is the local network of the client computer 18 in the present embodiment). As yet another example, the safeguarding action is a “block” type safeguarding action. The block type safeguarding action refers to an action that prevents the natural language model input from being sent out of its local network, which, in the present embodiment, is the local client network 12.

With reference back to FIG. 3, and continued reference to FIG. 5, the actions assigner 38 may implement the process 200 of FIG. 5, at least in one embodiment. In the present embodiment, the actions assigner 38 is used for performing two main functions: classification of sensitive information items, and assignment of safeguarding actions based on the classification. Classification here refers is used in its general sense, as appreciated in the art, of identifying or selecting a class (or multiple classes) from a set of predefined classes, where the set of predefined classes here is a plurality of predetermined classes.

The classification of the actions assigner 38 is carried out over the detected information, corresponding to the sensitive information detection data 202 (FIG. 5) in the present embodiment. This data 202 refers to information that represents the detected sensitive information (as one or more sensitive information items) and which may exist in a variety of different forms, such as, for example, a hash map containing a list of detected sensitive information hash items that each indicate the position and characters comprising the portion of the natural language model input giving rise or otherwise evoking a positive detection; as another embodiment, a dictionary or JavaScript Object Notation (JSON) is used as the detected information. Likewise, output of the actions assigner 38, namely the information-actions map 208 at least in the embodiment of FIG. 5, may exist in any of a number of different, suitable forms, such as, for example, JSON form, a Python dictionary, a hash map, etc.

Configuration information is provided to the actions assigner 38 in the form of configuration data and used by the actions assigner 38; for example, in the embodiment of FIG. 5, administrative configuration information is shown as being input into the action assignment/classification step 206. According to embodiments, administrative configuration information is determined for a given sensitive information item based on a detection type for that given sensitive information item; as used herein, “detection type”, when used in connection with a given sensitive information item, refers to a type or manner in which the given sensitive information was detected and/or a type or classification of content constituting the given sensitive information, where the type here (albeit a manner, classification, or kind) is specifically selected from or otherwise identified amongst a given predefined set of classes or groups. The given predefined set of classes or groups referred to here in the previous sentence is referred to herein as a “set of predefined detection types”.

For each sensitive information item contained or otherwise indicated by the sensitive information detection data 202, a detection type is determined for its corresponding sensitive information whereby the detection type is one selected from a set of predefined detection types. The set of predefined detection types may be a set that includes any combination of one or more of the predefined detection types specified in Table 1; for example, in embodiments, the set of predefined detection types includes all of those predefined detection types set forth in Table 1. Of course, in other embodiments, the predefined detection types used as constituting the set of predefined detection types includes other detection types, as those in Table 1 are but some examples.

After and in response to the detection type for the sensitive information item being determined, configuration data is obtained based on the detection type. In embodiments, the configuration information includes rules defining which safeguarding action to assign to each detection type; that is, for example, when two sensitive information items are detected in the natural language model input, the detection type for each of the two sensitive information items are determined and then used in combination with the configuration data to identify or otherwise determined a safeguarding action for the two sensitive information items. For even further insight, consider the preceding example, but further extended according to an exemplary scenario in which the detection types of the sensitive information items are the same; as a result, for the two sensitive information items of the same detection type, the same configuration information is used for determining the corresponding safeguarding action and, accordingly, is obtained for both of these two sensitive information items together; thus, in embodiments, configuration information is determined only for each different detection type of those detection type(s) of the sensitive information item(s) of the natural language model input.

In embodiments, the configuration information is in the form of a hash map (“ConfigRules”) that specifies configuration rules defining which safeguarding action to assign to each detection type of sensitive information. Thus, in such an embodiment, this hash map is consulted using the detection type(s) corresponding to those sensitive information item(s) of the natural language model input. The hash map (or configuration data) may be predefined and exist as predetermined data that is stored in memory, periodically updated, and maintained by the client-side NLP safeguarding tool 22 within the local client network 12, at least in some embodiments.

The output of the actions assigner 38 is used for indicating the safeguarding action(s) to carry out and, at least in some embodiments, also specifies parameter information used for effecting customized performance of the safeguarding action. Here, this parameter information is used for indicating parameter values used for processing and effectuation of the safeguarding action for which it is associated with. In the present embodiment, for example, the parameter information simply corresponds to and is constituted by three textual character string arrays, specifically: one for block type safeguarding action(s), one for warn type safeguarding action(s), and one for block type safeguarding action(s); these textual character arrays each include the sensitive information of the natural language model input, such as, for example, a URL (“https://docs.google.com/”), a date (“02-14-1998”), a phone number “phone number+1 602-334-3443”. In some embodiments, the parameter information includes other values or information, and this information may be tailored to the particular detection type and/or use case in which the client-side NLP data safeguarding tool 22 is being used, as customized results may be desirable for different use cases, in different scenarios, or under different conditions.

The actions assigner 38 then provides the information-actions map 208 (or other information indicative of one or more safeguarding actions) to the actions handler 40. In the present embodiment, the actions handler 40 uses the information-actions map 208 in order to execute or otherwise cause execution of the safeguarding action as indicated by the information-actions map 208; and, further, in embodiments employing customizable safeguarding actions, the actions handler 40 effects or otherwise causes execution of the safeguarding action in accordance with parameter information.

In the present embodiment, the actions assigner 38 is used to assign: a block action that prevents the submissions of sensitive information entirely; a warn action that informs the user of the presence of sensitive information and provides an option to accept or decline the submission; or a mask action that replaces sensitive information with characters, numbers, shapes, or symbols in a way that maintains the prompt's meaning and context. In embodiments, the output of the actions assigner 38 is a hash map, which is referred to as an information-action map (IAM), which is discussed more below.

According to embodiments, the actions assigner 38 includes the following components: (1) a Unified Classification and Assignment function; and an Information-Action Map. The Unified Classification and Assignment function is used for classifying each piece of detected sensitive information based on predefined action configuration rules and for assigning each piece of detected sensitive information to an action, which is represented in the IAM. In the present embodiment, the input into the Unified Classification and Assignment function includes: DetectedInfo (a hash map containing lists of detected sensitive information items from the sensitive information detector 36,100, e.g., emails, dates, credit cards); and ConfigRules (a hash map of configuration rules defining which action to assign to each type of sensitive information item). In the present embodiment, the output of the Unified Classification and Assignment function is the IAM, which, in the present embodiment, is a hash map containing the actions and the assigned sensitive information).

In regards to the operations of the Unified Classification and Assignment function, four operations are performed in the present embodiment: (1) an initialize operation to initialize the Information-Action Map; (2) an extract detected information types operation; (3) an apply configuration rules and assign to actions operation; and (4) an output operation that returns the complete (populated) IAM. In regards to (1), the IAM is initialized, for example, as:
IAM={Block: [ ],Warn: [ ],Mask: [ ]}
   In regards to (2), for each detected type Tᵢ (e.g., SSN, email, credit card) in DetectedInfo, a list of matches is obtained:
DetectedItems(Tᵢ)=DetectedInfo[Tᵢ]
   In regards to (3), for each type Tᵢ, ConfigRules is consulted to determine the assigned action:
Action(Tᵢ)=ConfigRules(Type(Tᵢ))
   Further, in regards to (3), the detected items are appended to their respective action in IAM:
IAM[Action(Tᵢ)]=IAM[Action(Tᵢ)]∪DetectedItems(Tᵢ)

In the present embodiment, the populated IAM is the final output of the actions assigner 38. Here, the IAM provides a structured map that contains the sensitive information classified under each action. In embodiments, this map helps in managing the protective measures for each detected item, ensuring appropriate actions are taken to safeguard sensitive data. An example of IAM is:

$$IAM = \{ \begin{matrix}Block : & [ “ credit card number 1234 - 4563 - 3443 - 3334 ” , … ] \\ Warn : & [ “ https : // docs . google . com / ” , “ 02 - 14 - 1998 ” , … ] \\ Mask : & [ “ phone number + 1 \; 602 - 334 - 3443 ” , … ]\end{matrix} \}$$

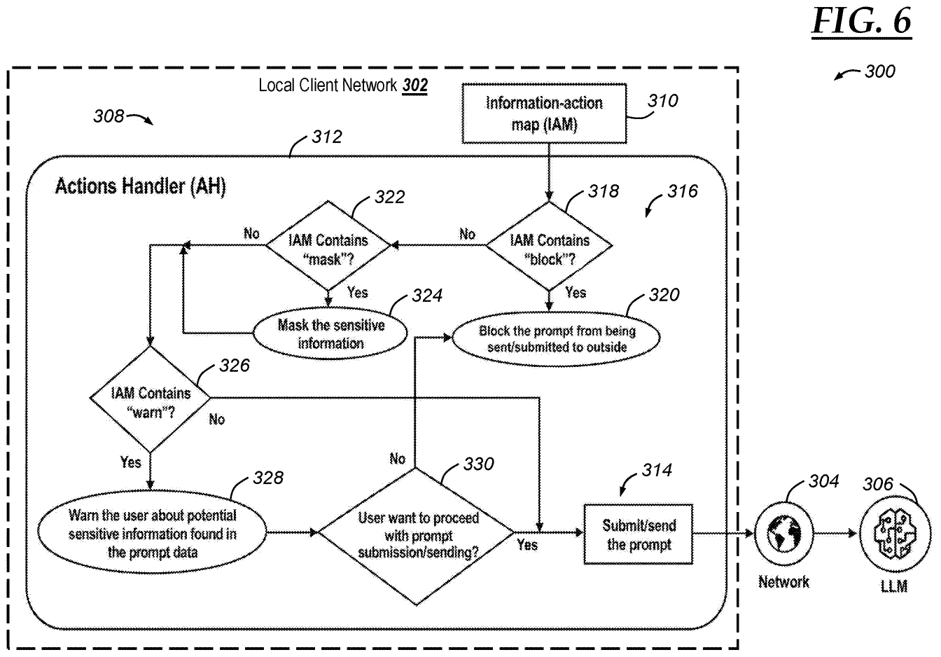

With reference now to FIG. 6, there is shown a computer communications system 300, according to one embodiment. The computer communications system 300 includes a local client network 302, an interconnected data communications network 304, and a third party NLP application 306. The local client network 302 is shown as including a client-side NLP data safeguarding tool 308, which has an information action map 310 and actions handler 312. The actions handler 312 is communicatively coupled to the interconnected data communications network 304 such that the actions handler 312 is capable of sending information to another network besides its network, such as, for example, the third party NLP application 306. In the present embodiment, the third party NLP application 306 is shown as including an LLM and configured for using the LLM to process the natural language model input as output by the actions handler 312, which is shown at 314 in the present embodiment of FIG. 6 as submission/sending of the prompt (referring to the natural language model input in its approved and/or desensitized state).

It will be appreciated that FIG. 6 embodies the client-side NLP data safeguarding tool 22 as a version detailing or more particularly describing aspects of the actions handler 40, and is thus described herein in an ostensibly technically-independent manner in that new reference numerals (e.g., 302, 304) are ascribed to the components shown and described with respect to FIG. 6. However, it will further be appreciated that the discussion and teachings of those like components provided for above in connection with FIGS. 1-5 is hereby incorporated and attributed to the corresponding components; for example, the local client network 302 corresponds to the local client network 12 and, as is hereby effected by the provision in the prior sentence, the discussion and teachings of the client-side NLP data safeguarding tool 22 is incorporated and attributed to the client-side NLP data safeguarding tool 308.

In embodiments, the system takes the prompt that the user wants to submit to LLM, and starts with detecting sensitive information in the sensitive information detector 36,100. In embodiments, all sensitive information found plus their locations in the prompt are then sent to the actions assigner 38, where the actions assigner 38 creates an information-action map (IAM) 208,310 containing the action-information elements, where each element is a pair of an information and the action that should be taken to protect it. In embodiments, there are three possible actions: “block”, “warn”, or “mask”. The IAM 208,310 is processed by the actions handler 40,312. According to embodiments, first, a check is performed to determine whether there is a ‘block’ action in the IAM 208,310. If yes, the NLP data safeguarding tool will entirely block the whole prompt submission such that no data will be exposed to the network nor sent/submitted to the LLM and the prompt data will remain only on the user's machine.

In continuing with the present embodiment as discussed in the previous paragraph, in the case where is no “block” action, the IAM 208,310 will be checked to see if it contains a “mask” action. If yes, the NLP data safeguarding tool will replace the sensitive information parts, such as, for example, with characters, numbers, shapes, or symbols in a way that preserves the prompt meaning and context without having sensitive information. Then, the NLP data safeguarding tool may proceed to the next check to see if the actions list contains “warn” action. Note that if there is no “mask” action in the actions list, the checking process may continue directly to the next step. In the present embodiment, if there is a “warn” action in the actions list, the NLP data safeguarding tool will inform the user about the sensitive information in the prompt and give two options: accept or decline the submission: if the user accepts, the NLP data safeguarding tool will allow the prompt to be sent/submitted to the LLM; and if the user declines, the NLP data safeguarding tool will block the submission as mentioned for the “block” action above.

The client-side NLP data safeguarding tool 308 is configured to instantiate and control the actions handler 312, particularly in order to carry out (and using the information-action map 310) a process 316 of performing a safeguarding action for a natural language model input. According to the present embodiment, the process 316 is useful for locally safeguarding sensitive information from a third party NLP application. The process 316 includes a first determination 318 as to whether there is a block type safeguarding action indicated in the information-actions map 310. If so, then the natural language model input is blocked from being sent/submitted to any device or network outside of the local client network 302, as shown at 320.

In embodiments, this step 320 is performed through use of a prompt submission blocking function. The prompt submission blocking function may be used to block the prompt submission if sensitive information is assigned the “block” action. According to one embodiment, the inputs of the prompt submission blocking function include: the IAM 208,310 and the prompt. Further, in embodiments, the output of the prompt submission blocking function include a status, which may be a string or Boolean that indicates whether the prompt is blocked or passed to the next step. According to embodiments, the prompt submission blocking function performs a block action checking operation and a decision operation. The block action checking operation is used to determine if any sensitive information is assigned to the “block” action: Block_{Items}=IAM[Block]. The decision operation blocks the operation if Block_Items≠Ø:

$$status = \{ \begin{matrix}Blocked , & if Block\_Items \neq ∅ \\ Continue , & otherwise\end{matrix}$$

The status (referred to as a “blocking status”) is then output by the prompt submission blocking function. If the first determination 318 is resolved in the negatory, the process 316 proceeds to a second determination 322.

The second determination 322 is a determination made as to whether there is a mask type safeguarding action indicated in the information-actions map 310. If the second determination 322 is resolved in the positive (“Yes”), the process 316 proceeds to step 324 whereat the natural language model input is desensitized (so as to mask sensitive information contained within the natural language model input and as indicated by the information-actions map 310) and, after this desensitized natural language model input is generated, the process 316 continues to a third determination 326.

In embodiments, this step 324 is performed through use of a prompt masking function. The prompt masking function may be used to mask sensitive information assigned to the “mask” action and replace it with characters, numbers, shapes, or symbols, preserving the prompt's meaning and context. In embodiments, the input of the prompt masking function includes the IAM 208,310 and the prompt. Further, in embodiments, the output of the prompt masking function includes masked_prompt, which is a string of the modified prompt with masked sensitive information.

In embodiments, the prompt masking function includes: a mask action checking operation; an apply masking operation; and a decision operation. The mask action checking operation is used to determine if any sensitive information is assigned the “mask” action: Mask_Items=IAM[Mask]. The apply masking operation replaces sensitive information with masked versions of that information if Mask_Items≠Ø:
masked_prompt=ApplyMasking(prompt, Mask_Items)
   The decision operation passes the original prompt is no masking is required or passes the masked prompt if masking is required:

$$masked\_prompt = \{ \begin{matrix}ApplyMasking ( prompt , Mast\_Items ) , & if Mask\_Items \neq ∅ \\ prompt , & otherwise\end{matrix}$$

The masked_prompt variable is then output by the prompt masking function. If the second determination 322 is resolved in the negatory (“No”), then the process 316 proceeds to the third determination 326 with the natural language model input not having been desensitized as in step 324.

The third determination 326 is a determination made as to whether there is a warn type safeguarding action indicated in the IAM 208,310. If the third determination 326 is resolved in the negatory (“No”), then the process 316 proceeds to output the natural language model input so as to cause submission and sending of the natural language model input in its processed form, which may include (in certain scenarios, for example, where step 324 is performed) the natural language model input in a desensitized form as a desensitized natural language model input. If the third determination 326 is resolved in the positive (“Yes”), the process 316 proceeds to step 328 whereat a fourth determination 330 is made.

In embodiments, this step 328 is performed through use of a warning and user decision function. The warning and user decision function may be used to warn the user about the presence of sensitive information assigned to the “warn” action and prompt the user to accept or decline the submission. In embodiments, the inputs of the warning and user decision function include: the IAM 208,310, the prompt, and a user response, which may be a string of the user's decision to accept or decline the submission. Further, in embodiments, the output of the warning and user decision function is final_status, which may be a string or Boolean indicating whether the prompt is submitted or blocked based on the user's decision.

In the present embodiment, the warning and user decision function includes: a warn action checking operation; a user interaction operation; and a decision operation. The warn action checking operation is used to determine if any sensitive information is assigned to the “warn” action: Warn_Items=IAM[Warn]. The user interaction operation is used to warn the user and capture their decision if Warn_Items≠Ø:

$$user\_response = \{ \begin{matrix}“ Accept ” , & if user accepts the submission \\ “ Decline ” , & if user declines the submission\end{matrix}$$

The decision operation is used to determine the final status based on the user's response:

$$final\_status = \{ \begin{matrix}“ Submitted ” , & if user\_response = “ Accept ” \\ “ Blocked ” , & if user\_response = “ Decline ”\end{matrix}$$

The warning and user decision function may then output the final status:

$$final\_status = \{ \begin{matrix}“ Submitted ” , & Warn\_Items \neq ∅ \\ final\_status , & otherwise\end{matrix}$$

The process 316 continues from step 328 to step 330.

The fourth determination 330 is a determination made as to whether the user wants to proceed with sending the natural language model input outside of the local client network 102, such as for submission to the LLM of the third party NLP application 306. For example, at step 330, the user may be presented a notification, such as in the form of a notification window or graphical object presented on a screen of the client computer 18, e.g., a browser alert-see the standard library alert function for JavaScript. In at least one embodiment, this notification indicates the natural language model input may include sensitive information and a query as to whether the user would like to proceed anyway with submission of the natural language model input, such as, for example, by providing “Yes” and “No” selectable buttons within the notification window allowing for the client-side NLP data safeguarding tool 308 to resolve the fourth determination 330 in accordance with which button is pressed or otherwise selected by the user. If the fourth determination 330 is resolved in the positive (“Yes”), the process 316 proceeds to output the natural language model input so as to cause submission and sending of the natural language model input in its processed form, which may include (in certain scenarios, for example, where step 324 is performed) the natural language model input in a desensitized form as a desensitized natural language model input; and, if the fourth determination 330 is resolved in the negatory (“No”), then the process 316 proceeds to step 320 whereat the natural language model input is blocked from being sent/submitted to any device or network outside of the local client network 302.

Thus, the process 316 is performable in order to safeguard information contained within a natural language model input to be sent out of the local client network 302. A final output of the process 316 (as indicated at 314) may be generated by the actions handler 312 through, such as, for example, use of a final decision flow process. In embodiments, the final decision flow process is implemented by the actions handler 312 through executing the block, masking, and/or warn functions as discussed herein. In embodiments, the decision flow may be summarized as:

$$Decision\_Flow = \{ \begin{matrix}Block , & if Block Items exist \\ Mask , & if no Block Items but Mask Items exist \\ Warn , & if no Block or Mask Items but Warn Items exist \\ Submit , & if none of the above\end{matrix}$$

The process 316 may be performed by the client-side NLP data safeguarding tool 308 again for subsequent natural language model inputs. Outputs of iterations of the process 316 may be stored in memory, such as the memory of the client computer or other device of the local client network 302.

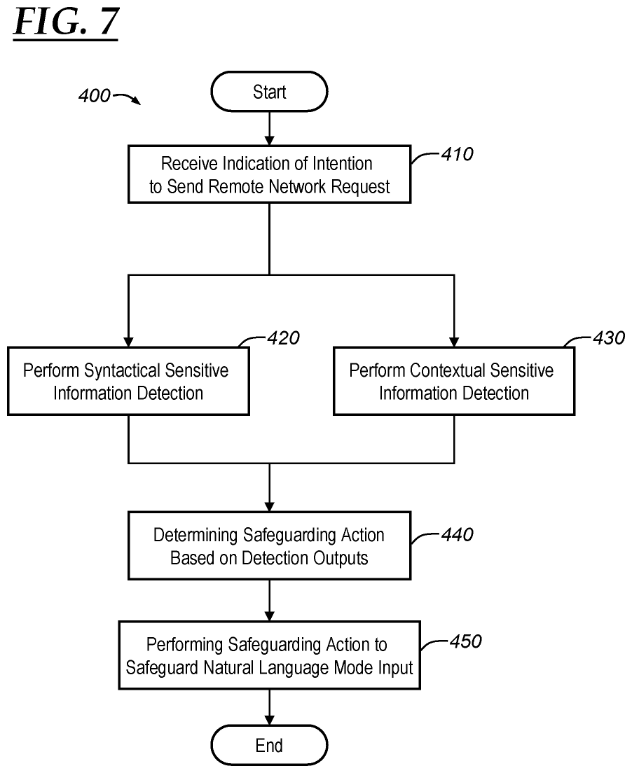

With reference to FIG. 7, there is shown a method 400 of locally safeguarding sensitive information from a third party natural language processing (NLP) application, according to one embodiment. According to at least one embodiment, the method 400 is carried out by the client-side NLP data safeguarding tool 22, particularly the safeguarding application 30 of the client computer 18. In such an embodiment, the method 400 is performed by the safeguarding application 30 in order to safeguard information contained within a natural language model input that is to be provided to the third party NLP computer system 14 and, in particular, an NLP computer application executed by the third party NLP computer system 14. Although the method 400 describes the following steps and operations as being performed in a particular order, in light of the following discussion and teachings herein, those skilled in the art will appreciate that the steps and operations of the method 400 may be performed according to any technically-feasible order.

The method 400 begins with step 410, wherein an indication of an intention of a computer application to send a remote network request to a third party NLP application is received. The host application 28 of the client computer 18 is configured to transmit a network request having a natural language model input out of the local client network 12 and to the third party NLP computer system 14; here, as the network request is for an endpoint that is not within the local client network 12, the network request is considered a “remote” network request. The remote network request has a natural language model input for the third party NLP application, such as in a payload of the remote network request, which may be, for example, a HTTP POST request that is sent via transmission control protocol (TCP)/internet protocol (IP) over the interconnected data communications network 16. In another embodiment, a HTTP GET request may be used, although may be (at least in certain scenarios) less preferable as, in an HTTP POST request, larger data transfer size is generally supported and data is not or less likely to be exposed in the URL, cached by browsers, and/or logged. The host application 28 prepares the remote network request based on, for example, user input received from a user via computer peripherals of the client computer 18, such as a keyboard, mouse, microphone, or other like human-machine interface (HMI) for receiving human input at a computer. In other embodiments, the host application 28 may automatically prepare and initial transmission of network requests with natural language model input, such as, for example, in response to triggering of predefined triggers configured within the host application 28 or in response to the host application 28 receiving data from another computer application of the client computer 18, gateway 20, other device of the local client network 12, or even the third party NLP computer system 14 or other non-local or remote computer system or device.

The safeguarding application 30 is configured in a manner so as to listen for network requests that are to be sent by the host application 28. In the illustrated embodiment, the safeguarding application 30 is an extension of the host application 28 and is permitted certain rights or privileges in terms of access to content and/or functionality within or otherwise made available by the host application 28. In an embodiment in which the host application 28 is a web browser, the safeguarding application 30 may intercept and analyze network requests before they are sent, allowing it to enforce data transmission policies, restrict oversized payloads, or log specific request details for security auditing. This can be achieved using the webRequest.onBeforeRequest API (supported by Google Chrome™, Mozilla Firefox™ Microsoft Edge™, other Chromium-based web browsers) which allows the safeguarding application 30 to inspect and modify outgoing requests in real-time.

The method 400 continues to steps 420 and 430, which are performed concurrently or asynchronously in the depicted embodiment. However, in another embodiment, step 420 is performed prior to step 430. And, in yet another embodiment, step 420 is performed after step 430. In the present embodiment, the steps 420 and 430 are performed asynchronously and simultaneously after and in response to receiving the indication in step 410, which allows for improved latency relative to synchronous processing in which steps 420 and 430 are performed in series. In such synchronous processing embodiments, processing may have increased latency, but may utilize less computational resources of the client computer 18 at any given time during processing, such as by having a reduced max RAM usage.

In step 420, syntactical sensitive information detection is performed on the natural language model input. In embodiments, the syntactical sensitive information detection is performed through executing textual pattern matching on the natural language model input in order to identify one or more matching text strings, such as through use of regular expressions as described above in connection with the syntactical sensitive information detector 106. In some embodiments, the textual pattern matching is a part of a textual pattern matching process that includes: identifying a text string within the natural language model input through use of a predefined text pattern (e.g., regular expression), determining distance information indicating a character distance between the text string and a keyword; and determining a detection result based on the character distance, such as the number of characters separating the keyword from the match as being below a predefined threshold, such as discussed above in connection with the syntactical sensitive information detector 106.

In embodiments, the textual pattern matching includes at least one of the following set of sensitive information types: Social Security Number (SSN) or other jurisdictional personal identifier detection, date detection, email detection, credit card number detection, phone number detection, address detection, financial account information detection, URL detection, and code snippet detection. In one embodiment, the textual pattern matching includes at least three of those types listed as a part of the set of sensitive information types.

The set of sensitive information types may include, at least in one embodiment: Social Security Number (SSN) or other jurisdictional personal identifier detection, which involves identifying unique personal identifiers issued by governments, such as U.S. Social Security Numbers (e.g., 123-45-6789) or other country-specific identification numbers like Canada's Social Insurance Number (SIN) or the UK's National Insurance Number (NIN); date detection, which identifies and extracts dates in various formats, such as MM/DD/YYYY, DD-MM-YYYY, or ISO 8601 formats (e.g., 2024-02-21); email detection, which involves recognizing and validating email addresses formatted as user@example.com; credit card number detection, which identifies structured numerical sequences used for payment processing, such as Visa, Mastercard, or AMEX numbers (e.g., 4111 1111 1111 1111 for Visa); phone number detection, which captures and validates phone numbers in different formats, including country codes and local conventions (e.g., +1-555-123-4567 or (555) 123-4567); address detection, which involves recognizing structured postal addresses, including street names, cities, states, zip codes, and country identifiers (e.g., 1600 Amphitheatre Parkway, Mountain View, CA 94043, USA); financial account information detection, which includes identifying sensitive banking details such as International Bank Account Numbers (IBAN) (e.g., DE44 5001 0517 5407 3249 31) or routing numbers; URL detection, which identifies and extracts web addresses formatted as standard hyperlinks (e.g., https://www.example.com); and code snippet detection, which involves detecting programming-related text that follows structured syntax, such as function definitions, variable declarations, or executable scripts (e.g., def hello worldo: print(“Hello, World!”) in Python). The method 400 continues to step 440, which begins after both step 420 and 430 are performed.

In step 430, contextual sensitive information detection is performed on the natural language model input. In at least one embodiment, the contextual sensitive information detector 108 is used. In embodiments, the contextual sensitive information detection is performed through use of a trained NLP model that uses the natural language model input as input. This then generates an output that is used as or for determining the output of the contextual sensitive information detection. In some embodiments, the output of the contextual sensitive information detection indicates a classification of an intent of sharing the natural language model input is benign or malicious. And, in some embodiments, the output of the contextual sensitive information detection is determined through tokenizing characters or strings of the natural language model input using the trained NLP model in order to generate tokenized input data, and where the tokenized input data indicates one or more key phrases or entities.

In one embodiment, the output of the contextual sensitive information detection is determined through: generating an output of a trained NLP model, wherein the output of the trained NLP model indicates an inferred aspect of the natural language model input; determining a confidence score for the inferred aspect of the natural language model input; and determining the output of the contextual sensitive information detection based on the confidence score. In one embodiment, the inferred aspect of the natural language model input is an intent of sharing the natural language model input, such as, for example, where the output of the contextual sensitive information detection indicates a classification of an intent of sharing the natural language model input is benign or malicious. The method 400 continues to step 440.

In step 440, determining a safeguarding action based on an output of the syntactical sensitive information detection and/or an output of the contextual sensitive information detection. In embodiments, the process 200 of FIG. 5 may be used for determining a safeguarding action, including, for example, one or more parameters to use when executing the safeguarding action, such as text content to be included in a warning or prompt presented to the user, for example, as a part of a warn type safeguarding action. In one embodiment, an information-action map (IAM) is determined based on the syntactical sensitive information detection of the natural language model input and the contextual sensitive information detection of the natural language model input. The method 400 continues to step 450.

In step 450, the safeguarding action is performed in order to safeguard information contained within the natural language model input. In one embodiment, a mask type safeguarding action is performed whereby the safeguarding application 30 generates a safeguarded natural language model input constituting a safeguarded version of the natural language model input and then causes the safeguarded natural language model input to be sent to the third party NLP application instead of the natural language model input. In yet another embodiment, the safeguarding action is a block type safeguarding action that when carried out prevents or otherwise inhibits the entire natural language model input from being sent out of the local client network 12 and/or to the third party NLP computer system 14. And, in yet another embodiment, the safeguarding action is a warn type safeguarding action in which a warning is provided, such as, for example, as described in step 328 whereby a user decision function (e.g., the warning and user decision function discussed above) is used. The method 400 then ends.

Thus, the method 400 is performable in order to safeguard information contained within a natural language model input to be sent out of a local client network, such as the local client network 12 or 302. The method 400 may be performed by the client-side NLP data safeguarding tool 22, 308 again for subsequent natural language model inputs. Outputs of iterations of the method 400 may be stored in memory, such as the memory of the client computer or other device of the local client network.

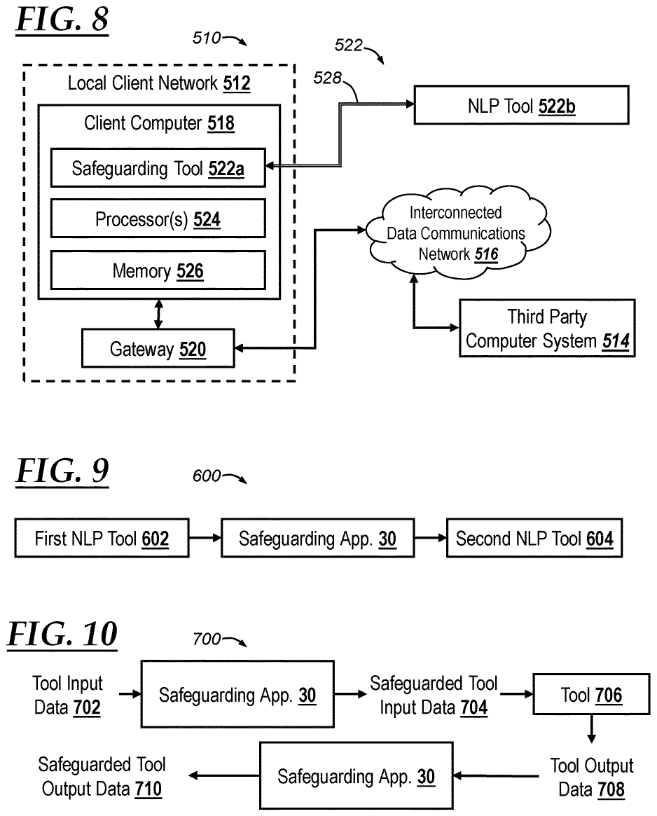

With reference to FIG. 8, there is shown another embodiment of a computer communications system 510 having a local client network 512, a third party NLP computer system 514, and an interconnected data communications network 516 for enabling electronic data communications between the local client network 512 and the third party NLP computer system 514. In the present embodiment, the local client network 512 has a client computer 518 as well as a gateway 520 for routing communications between the client computer 518 and the interconnected data communications network 516. The client computer 518 is used for determining a natural language model input to be sent via the gateway 20 to the third party NLP computer system 14 for processing, but this natural language model input is captured or otherwise obtained and evaluated or otherwise inspected by a data safeguarding tool 522.

The data safeguarding tool 522 is an example of a computer tool for safeguarding data, such as content comprised of natural language text (e.g., English characters as in this document), graphics, images, or other human-interpretable subject matter, and includes an on-premise or local portion 522a as well as an off-premise or remote portion 522b. In such an embodiment, the local portion 522a and the remote portion 522b are communicatively connected via a secured, private data communications channel 528. The private data communications channel 528 may be established using virtual private network (VPN) technology, secure socket layer (SSL)/transport layer security (TLS) protocols, or other cryptographically secure communication mechanisms, for example.

In one embodiment, the remote portion 522b of the data safeguarding tool 522 is used for performing contextual analysis, such as that which is described above as being performed by the contextual sensitive information detector 108. Thus, according to at least one embodiment, the multifaceted detection framework 104 of FIG. 4 is implemented by the safeguarding tool 522, such as, for example, with the remote portion 522b being used for implementing the contextual sensitive information detector 108 and/or portions thereof. For example, in one embodiment, the entire contextual sensitive information detector 108 is performed by the remote portion 522b; in another embodiment, the semantic analysis 118 is performed locally at the local portion 522a and the deep context understanding 120 is performed at the remote portion 522b. Of course, other combinations or data processing frameworks may be used, according to various embodiments.

With reference to FIG. 9, there is shown an embodiment of an artificial intelligence (AI) lingual agent communication system 600 having a first NLP tool 602, the safeguarding application 30, and a second NLP tool 604. The first NLP tool 602 may be a first LLM and the second NLP tool 604 may be a second LLM having a different configuration or LLM model than the first LLM. In other embodiments, the second NLP tool 604 may have the same configuration as the first LLM and/or may use the same LLM as the first NLP tool 602. The output of the first NLP tool 602 is provided to the safeguarding application 30, which then generates a safeguarded output (referred to as a “safeguarded first NLP tool output”). The safeguarded first NLP tool output is then passed to the second NLP tool 604.

In one embodiment, the first NLP tool 602 and/or the second NLP tool 604 are each configured as an LLM-based agent. For example, when each of the first NLP tool 602 and/or the second NLP tool 604 is an agent, the safeguarding application 30 safeguards agent-to-agent (A2A) interactions so as to provide a safeguarded agent-to-agent communication system. Further, in in one embodiment, the first NLP tool 602 and/or the second NLP tool 604 are each configured as a separate computer application, which may run on the same computer (machine) or different computers (machines). For example, when each of the first NLP tool 602 and/or the second NLP tool 604 is a separate computer application, the safeguarding application 30 safeguards application-to-application (App-to-App) interactions so as to provide a safeguarded application-to-application communication system.

With reference to FIG. 10, there is shown an embodiment of an AI and tool data pass communication system 700 having the safeguarding application 30 and a tool 706. In the present embodiment, tool input data 702 is first passed to the safeguarding application 30, which then generates safeguarded tool input data 704. The safeguarded tool input data 704 is then passed to the tool 706 as input. The tool 706 then uses this safeguarded tool input data 704 to generate tool output data 708. The tool output data 708 is then passed to the safeguarding application 30, which then generates and outputs safeguarded tool output data 710. According to embodiments, the AI and tool data pass communication system 700 may be incorporated into the system 600 and used to safeguard information used by the first NLP tool 602 and/or the second NLP tool 604, such as, for example, when an agent determines to use a tool as a part of its processing. Thus, according to embodiments, the AI and tool data pass communication system 700 is used for background communication when AI agents interact with other software apps or agents automatically. Accordingly, in embodiments, because this happens fast through APIs and code (like JSON data), the system 700 is capable of checking these programmatic interactions in real-time and makes sure no sensitive data leaks when these autonomous systems trigger actions in each other.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.” Furthermore, in spite of this express clarification of “and/or”, the use of “or” (without the “and/” prepend thereto) herein does not necessarily denote an exclusive OR and, as is hereby provided, is to be interpreted in the same manner as the term “and/or” unless this would result in teachings that are technically defunct or otherwise infeasible.

1. A method of locally safeguarding sensitive information from a third party natural language processing (NLP) application, comprising:
receiving an indication of an intention of a native computer application to send a remote network request to a third party NLP application, wherein the remote network request has a natural language model input for the third party NLP application;
performing syntactical sensitive information detection on the natural language model input;
performing contextual sensitive information detection on the natural language model input;
determining a safeguarding action based on an output of the syntactical sensitive information detection and/or an output of the contextual sensitive information detection; and
performing the safeguarding action in order to safeguard sensitive information contained within the natural language model input.

2. The method of claim 1, wherein the steps of the method are each performed by the client computer so that the safeguarded natural language model input is generated at the client computer and sent by the client computer using a network interface of the client computer.

3. The method of claim 1, wherein the native computer application is a web browser for browsing the internet or other remote computer networks.

4. The method of claim 1, wherein the syntactical sensitive information detection is performed through executing textual pattern matching on the natural language model input in order to identify one or more matching text strings.

5. The method of claim 4, wherein the textual pattern matching includes one or more regular expressions.

6. The method of claim 4, wherein the textual pattern matching is a part of a textual pattern matching process that includes:
identifying a text string within the natural language model input through use of a predefined text pattern,
determining distance information indicating a character distance between the text string and a keyword; and
determining a detection result based on the character distance, wherein the output of the syntactical sensitive information detection is based on the detection result.

7. The method of claim 4, wherein the textual pattern matching includes at least one of from a list consisting of: Social Security Number (SSN) or other jurisdictional personal identifier detection, date detection, email detection, credit card number detection, phone number detection, address detection, financial account information detection, URL detection, and code snippet detection.

8. The method of claim 7, wherein the textual pattern matching includes at least three from the list.

9. The method of claim 1, wherein the output of the contextual sensitive information detection is based on an output generated by a trained NLP model operating on the natural language model input.

10. The method of claim 1, wherein the output of the contextual sensitive information detection indicates a classification of an intent of sharing the natural language model input, and wherein the classification indicates whether the intent of sharing the natural language model input is benign or malicious.

11. The method of claim 1, wherein the output of the contextual sensitive information detection is determined through tokenizing characters or strings of the natural language model input using the trained NLP model in order to generate tokenized input data, and wherein the tokenized input data indicates one or more key phrases or entities.

12. The method of claim 1, wherein the output of the contextual sensitive information detection is determined through performing inference on the natural language model input using the trained NLP model.

13. The method of claim 12, wherein the trained NLP model produces an output as a result of performing the inference on the natural language model input, and wherein the output of the trained NLP model indicates an intent of sharing the natural language model input to another party.

14. The method of claim 13, wherein the trained NLP model includes a neural network (NN) that performs the inference on the natural language model input in order to generate the output of the contextual sensitive information detection.

15. The method of claim 1, wherein the output of the contextual sensitive information detection is determined through:
generating an output of a trained NLP model, wherein the output of the trained NLP model indicates an inferred aspect of the natural language model input;
determining a confidence score for the inferred aspect of the natural language model input; and
determining the output of the contextual sensitive information detection based on the confidence score.

16. The method of claim 15, wherein the inferred aspect of the natural language model input is an intent of sharing the natural language model input, and wherein the output of the contextual sensitive information detection indicates a classification of the intent of sharing the natural language model input.

17. The method of claim 1, wherein the safeguarding action is prompting a user with information concerning sensitive information detected within the natural language model input.

18. The method of claim 1, wherein the safeguarding action includes generating a safeguarded natural language model input constituting a safeguarded version of the natural language model input and causing the safeguarded natural language model input to be sent to the third party NLP application instead of the natural language model input, and wherein sensitive information detected within the natural language model input is redacted or otherwise masked and the safeguarded natural language model input thereby generated prior to any version of the natural language model input being sent out of a local network of the client computer.

19. The method of claim 1, wherein an information-action map (IAM) is determined based on the syntactical sensitive information detection of the natural language model input and the contextual sensitive information detection of the natural language model input.

20. A client-side data safeguarding tool, comprising:
a host application interface for communication with a computer application being executed on a client computer, wherein the computer application is a web browser;
a sensitive information detector for detecting sensitive information contained within a natural language model input to be sent over a data communications network to an application hosted by a third party;
an actions assigner for receiving sensitive information data concerning the sensitive information and assigning an action to the sensitive information data; and
an actions handler for causing execution of the assigned action in order to include a safeguarded version of the sensitive information in place of the sensitive information as originally presented in the natural language model input.
